(19) United States
(12) Patent Application Publication
(10) Pub. No.: US 2012/0063613 A1
(43) Pub. Date: Mar. 15, 2012

(54) RECORDING APPARATUS, RECORDING CONDITION SETTING METHOD, AND NON-TRANSITORY COMPUTER-READABLE RECORDING MEDIUM ENCODED WITH RECORDING CONDITION SETTING PROGRAM

(75) Inventors: Hiroyoshi Sato, Osaka (JP); Hitoshi Miyamoto, Osaka (JP); Masaharu Sawai, Souraku-gun (JP)

(73) Assignee: SANYO ELECTRIC CO., LTD., Osaka (JP)

(21) Appl. No.: 13/156,748

(22) Filed: Jun. 9, 2011

(30) Foreign Application Priority Data
Sep. 13, 2010 (JP) 2010-204941
Oct. 8, 2010 (JP) 2010-229142
Dec. 22, 2010 (JP) 2010-285368

(51) Int. Cl. H04R 3/00

(52) U.S. Cl. 381/92

(57) ABSTRACT

A recording apparatus includes: a plurality of microphones having directivity to output collected sound; a switch portion to switch a direction of directivity of each of the plurality of microphones to one of a plurality of predetermined direction patterns; a detection portion to detect a direction pattern switched by the switch portion among the plurality of direction patterns; a recording portion to execute plural kinds of processing on sound collected by the plurality of microphones and to record the processed sound; a setting portion to set parameters to be used by the recording portion to execute the plural kinds of processing; and a storage portion to store the parameters to be used by the recording portion to execute the plural kinds of processing, separately for each of the plural kinds of processing, in association with each of the plurality of direction patterns. When a direction pattern switched by the switch portion is detected by the detection portion, the setting portion sets the parameters to be used to execute plural kinds of processing that are associated with the detected direction pattern.

This application is based on Japanese Patent Applications Nos. 2010-204941, 2010-229142, and 2010-285368 filed with Japan Patent Office on Sep. 13, 2010, on Oct. 8, 2010, and on Dec. 22, 2010, respectively, the entire contents of which are hereby incorporated by reference.

### BACKGROUND OF THE INVENTION

1. Field of the Invention

The present invention relates to a recording apparatus, a recording condition setting method, and a non-transitory computer-readable recording medium encoded with a recording condition setting program. More particularly, the present invention relates to a recording apparatus having a plurality of microphones, a recording condition setting method executed in the recording apparatus, and a non-transitory computer-readable recording medium encoded with a recording condition setting program.

2. Description of the Related Art

There is a known sound recording/reproduction apparatus having a directional microphone and a non-directional microphone, which is capable of switching between recording conditions for recording a sound signal from the directional microphone and recording conditions for recording a sound signal from the non-directional microphone.

However, in order to switch the recording conditions in the conventional sound recording/reproduction apparatus, the user has to determine a sound source and determine which of the directional microphone and the non-directional microphone is suitable for recording a sound signal. Moreover, conventionally, in order to switch the recording conditions, the user has to start from a menu screen and go to a lower-level screen for switching the recording conditions. The operation of switching the recording conditions is thus cumbersome.

### SUMMARY OF THE INVENTION

In accordance with an aspect of the present invention, a recording apparatus includes: a plurality of microphones having directivity to output collected sound; a switch portion to switch a direction of directivity of each of the plurality of microphones to one of a plurality of predetermined direction patterns; a detection portion to detect a direction pattern switched by the switch portion among the plurality of direction patterns; a recording portion to execute plural kinds of processing on sound collected by the plurality of microphones and to record the processed sound; a setting portion to set parameters to be used by the recording portion to execute the plural kinds of processing; and a storage portion to store the parameters to be used by the recording portion to execute the plural kinds of processing, separately for each of the plural kinds of processing, in association with each of the plurality of direction patterns. When a direction pattern switched by the switch portion is detected by the detection portion, the setting portion sets the parameters to be used to execute plural kinds of processing that are associated with the detected direction pattern.

In accordance with another aspect of the present invention, a recording apparatus having a plurality of microphones to collect sound includes: a first microphone and a second microphone having no directivity; a third microphone having directivity; a moving portion to allow the third microphone to move, from an accommodation position in which the third microphone is accommodated in an arrangement surface of a housing on which the first microphone and the second microphone are arranged, to a protrusion position in which the third microphone is protruded with respect to the arrangement surface; and a setting portion to set any one of a plurality of recording conditions as a condition for recording, in accordance with the position of the third microphone.

In accordance with another aspect of the present invention, a recording condition setting method is executed in a recording apparatus including a plurality of microphones having directivity to output collected sound, a switch portion to switch a direction of directivity of each of the plurality of microphones to one of a plurality of predetermined direction patterns, a recording portion to execute plural kinds of processing on sound collected by a plurality of microphones and to record the processed sound and a storage portion to store parameters to be used by the recording portion to execute the plural kinds of process, separately for each of the plural kinds of processing, in association with each of the plurality of direction patterns. The method includes the steps of detecting a direction pattern switched by the switch portion among the plurality of direction patterns; and setting the parameters to be used to execute plural kinds of processing that are associated with the detected direction pattern, when a direction pattern switched by the switch portion is detected in said step of detecting.

In accordance with a further aspect of the present invention, a non-transitory computer-readable recording medium is encoded with a recording condition setting program executed in a computer controlling a recording apparatus including a plurality of microphones having directivity to output collected sound, a switch portion to switch a direction of directivity of each of the plurality of microphones to one of a plurality of predetermined direction patterns, a recording portion to execute plural kinds of processing on sound collected by a plurality of microphones and to record the processed sound and a storage portion to store parameters to be used by the recording portion to execute the plural kinds of process, separately for each of the plural kinds of processing, in association with each of the plurality of direction patterns. The recording condition setting program causes the computer to execute processing comprising the steps of detecting a direction pattern switched by the switch portion among the plurality of direction patterns; and setting the parameters to be used to execute plural kinds of processing that are associated with the detected direction pattern, when a direction pattern switched by the switch portion is detected in said step of detecting.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of an IC recorder in a first embodiment of the present invention.

FIG. 2 shows an exemplary first direction pattern.

FIG. 3 shows an exemplary second direction pattern.

FIG. 4 shows an exemplary third direction pattern.

FIG. 5 is a functional block diagram showing an overall hardware configuration of the IC recorder.

FIG. 6 is a functional block diagram showing an overall function of CPU together with data stored in EEPROM in accordance with the first embodiment.

FIG. 7 shows an exemplary basic screen.

FIG. 8A to FIG. 8D each show an exemplary scene select screen.

FIG. 9 shows an exemplary association table.

FIG. 10 shows an exemplary direction pattern table.

FIG. 11 shows an exemplary first recommended scene determination screen.

FIG. 12 shows an exemplary second recommended scene determination screen.

FIG. 13 shows an exemplary third recommended scene determination screen.

FIG. 14 is a flowchart showing an exemplary flow of a recording process.

FIG. 15 is a flowchart showing an exemplary flow of a first recording setting process.

FIG. 16 is a flowchart showing an exemplary flow of a parameter setting process.

FIG. 17 is a flowchart showing an exemplary flow of a second recording setting process.

FIG. 18 is a front view of an IC recorder in a second embodiment of the present invention.

FIG. 19 is a perspective view of the IC recorder in the second embodiment.

FIG. 20 is a front view of the IC recorder in the second embodiment.

FIG. 21 is a perspective view of the IC recorder in the second embodiment.

FIG. 22 is a front view partially showing the IC recorder with a microphone unit held in a first position in the second embodiment.

FIG. 23 is a perspective view partially showing the IC recorder with the microphone unit held in the first position in the second embodiment.

FIG. 24 is a rear view showing another part of the IC recorder with the microphone unit held in the first position in the second embodiment.

FIG. 25 is a perspective view showing another part of the IC recorder with the microphone unit held in the first position in the second embodiment.

FIG. 26 is a top view partially showing the IC recorder with the microphone unit held in the first position in the second embodiment.

FIG. 27 is a cross-sectional view partially showing the IC recorder with the microphone unit held in the first position in the second embodiment.

FIG. 28 is a front view partially showing the IC recorder with the microphone unit held in a second position in the second embodiment.

FIG. 29 is a perspective view partially showing the IC recorder with the microphone unit held in the second position in the second embodiment.

FIG. 30 is a top view partially showing the IC recorder with the microphone unit held in the second position in the second embodiment.

FIG. 31 is a cross-sectional view partially showing the IC recorder with the microphone unit held in the second position in the second embodiment.

FIG. 32 is a cross-sectional view partially showing the IC recorder with the microphone unit held in the first position in the second embodiment.

FIG. 33 is a block diagram partially showing a circuit configuration of the IC recorder in the second embodiment.

FIG. 34 is an illustration showing a microphone table showing the relation between the microphones and the positions of the microphone unit in the IC recorder in the second embodiment.

FIG. 35 is an illustration showing an operation manner of the IC recorder in the second embodiment.

FIG. 36 is an illustration showing a sensitivity table A showing the relation between sensitivity and the positions of the microphone unit in the IC recorder in the second embodiment.

FIG. 37 is an illustration showing a sensitivity table B showing the relation between sensitivity and the positions of the microphone unit in the IC recorder in the second embodiment.

FIG. 38 is a flowchart showing a part of operations of the IC recorder in the second embodiment.

FIG. 39 is a flowchart showing the following part of operations of the IC recorder in the second embodiment.

FIG. 40 is a front view schematically showing a part of the IC recorder with the microphone unit held in the first position in a modification of the second embodiment.

FIG. 41 is a front view schematically showing a part of the IC recorder with the microphone unit held in the second position in the modification of the second embodiment.

FIG. 42 is a table showing the relation between the positions of the microphone unit and marks in the modification of the second embodiment.

FIG. 43 shows an exemplary display screen in the modification of the second embodiment.

FIG. 44 shows another example of the display screen in the modification of the second embodiment.

FIG. 45 is a table showing the relation between the recording scenes and the recommended parameters of recording function setting items in the modification of the second embodiment.

FIG. 46 shows a transition of the display screen in the modification of the second embodiment.

FIG. 47 is a flowchart showing another part of operations of the IC recorder in the modification of the second embodiment.

FIG. 48 is a flowchart showing the following another part of operations of the IC recorder in the modification of the second embodiment.

### DESCRIPTION OF THE PREFERRED EMBODIMENTS

The preferred embodiments of the present invention will be described below in conjunction with the drawings. In the following description, the same or corresponding parts are denoted by the same reference characters. Their names and functions are also the same. Thus, a detailed description thereof will not be repeated.

### First Embodiment

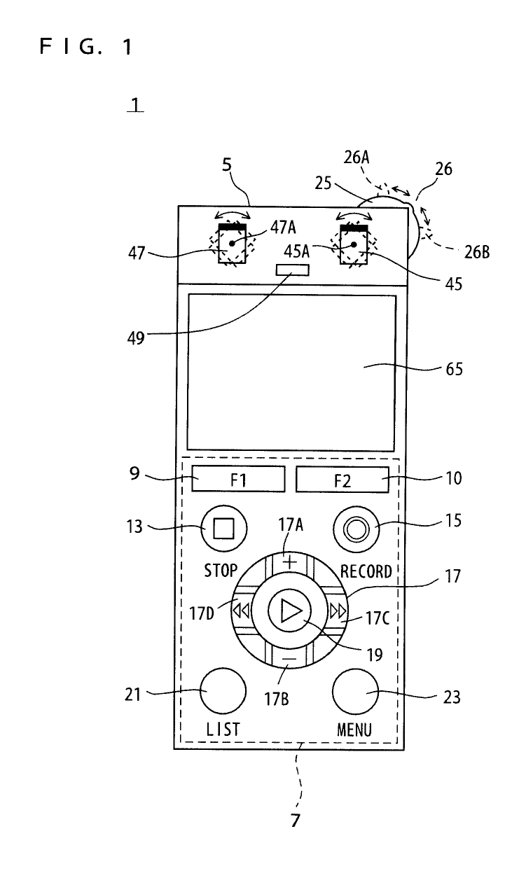

FIG. 1 is a plan view of an IC recorder in a first embodiment of the present invention. An IC recorder 1 includes a sound collecting unit 5, an LCD (Liquid Crystal Display) 65, and an operation unit 7. It is noted that the dotted lines and the arrows in the figure are given for the sake of illustration and actually do not exist. LCD 65 is provided on a front surface of IC recorder 1 to display an image. LCD 65 may be replaced with any other display such as an organic ELD (Electroluminescence Display) as long as it can display an image.

Operation unit 7 includes a plurality of hard keys arranged on the front surface of IC recorder 1. Each of a plurality of hard keys is usually off and is turned on when pressed by the user. A plurality of hard keys include a first function button 9, a second function button 10, a stop button 13, a record button 15, a control button 17, an OK button 19, a list button 21, and a menu button 23.

First function button 9 and second function button 10 each correspond to a soft key displayed at a prescribed location in LCD 65. When the user presses first function button 9, operation unit 7 outputs a signal indicating that the soft key corresponding to first function button 9 is pressed. When the user presses second function button 10, operation unit 7 outputs a signal indicating that the soft key corresponding to second function button 10 is pressed. Therefore, plural kinds of soft keys can be displayed on LCD 65.

Record button 15 is a button to which an operation of designating start of recording is allocated. OK button 19 is a button to which an operation of designating reproduction of sound is allocated. Stop button 13 is a button to which an operation of designating stop of sound reproduction is allocated. List button 21 is a button to which an operation of designating display of a list of names of recorded sound data and/or a list of names of folders storing sound data is allocated. Menu button 23 is a button to which an operation of designating display of a menu screen is allocated. The menu screen is a screen to display a plurality of setting screens for setting set values for performing a plurality of functions of IC recorder 1. In the menu screen, the names of the plurality of functions are displayed in a list in a selectable manner. The plurality of functions include a recording function, a replay function, and a file edit function.

Control button 17 includes an up button 17A, a down button 17B, a right button 17C, and a left button 17D. Up button 17A, down button 17B, right button 17C, and left button 17D accept an operation of selecting a choice displayed on LCD 65, an operation of switching screens appearing on LCD 65, and the like.

Sound collecting unit 5 includes a dial 25, a first directional microphone 45, a second directional microphone 47, and a non-directional microphone 49. Dial 25 is attached to sound collecting unit 5 so as to be rotatable about a rotation axis vertical to the display surface of LCD 65. Dial 25 has a projection portion 26 protruding outward of sound collecting unit 5. Since projection portion 26 protrudes outward of sound collecting unit 5, the user can touch projection portion 26 and can rotate dial 25 by exerting force on projection portion 26. Although dial 25 partially projects on the outside of sound collecting unit 5 in FIG. 1, projection portion 26 at least protrudes on the outside of sound collecting unit 5.

The position of dial 25 changes as dial 25 is rotated. Here, predetermined three positions that can be assumed by dial 25 are referred to as a first position, a second position, and a third position. In FIG. 1, projection portion 26 is shown by the solid line when dial 25 is in the first position, projection portion 26A is shown by the dotted line when dial 25 is in the second position, and projection portion 26B is shown by the dotted line when dial 25 is in the third position. The second position is a position where dial 25 is rotated counterclockwise about the rotation axis by a prescribed angle from the first position. The third position is a position where dial 25 is rotated clockwise about the rotation axis by a prescribed angle from the first position. The prescribed angle is smaller than 180°.

First directional microphone 45 is rotatably attached to sound collecting unit 5 such that its directional direction (hereinafter referred to as “the first directional direction”) is vertical to a rotation axis 45A. Second directional microphone 47 is rotatably attached to sound collecting unit 5 such that its directional direction (hereinafter referred to as “the second directional direction”) is vertical to a rotation axis 47A. The respective rotation axes 45A and 47A of first directional microphone 45 and second directional microphone 47 are parallel to the rotation axis of dial 25. First directional microphone 45 and second directional microphone 47 are mechanically coupled to dial 25, for example, by a gear, so that they rotate in connection with the rotation of dial 25.

Therefore, the directional directions of first directional microphone 45 and second directional microphone 47 change in connection with the rotation of dial 25, and the first directional direction and the second directional direction are each fixed to one direction corresponding to the position of dial 25. Here, a combination of the first directional direction and the second directional direction is referred to as a direction pattern, where the direction pattern corresponding to the first position of dial 25 is referred to as a first direction pattern, the direction pattern corresponding to the second position of dial 25 is referred to as a second direction pattern, and the direction pattern corresponding to the third position of dial 25 is referred to as a third direction pattern.

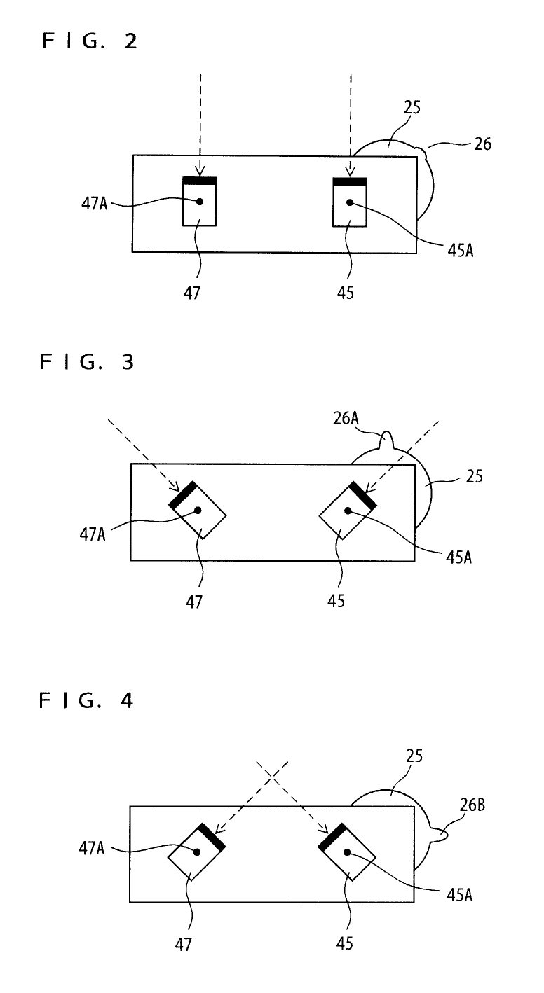

FIG. 2 shows an exemplary first direction pattern. First directional microphone 45 is rotatable about rotation axis 45A. Second directional microphone 47 is rotatable about rotation axis 47A. The dotted arrow towards first directional microphone 45 shows the first directional direction. The dotted arrow towards second directional microphone 47 shows the second directional direction. The first directional direction and the second directional direction are parallel to each other in the first direction pattern. Therefore, first directional microphone 45 and second directional microphone 47 in the first direction pattern are suitable for collecting sounds produced in the same direction, that is, sounds in a prescribed direction such as the forward direction, for example, when a person speaks in front of people.

FIG. 3 shows an exemplary second direction pattern. The dotted arrow towards first directional microphone 45 shows the first directional direction. The dotted line toward second directional microphone 47 shows the second directional direction. In the second direction pattern, the first directional direction is a direction rotated counterclockwise by a prescribed angle from the first directional direction in the first direction pattern, and the second directional direction is a direction rotated clockwise by a prescribed angle from the second directional direction in the first direction pattern. Therefore, in the second direction pattern, first directional microphone 45 collects sounds produced to the right side from the top in the figure, and second directional microphone 47 collects sounds produced to the left side from the top in the figure. Therefore, the second direction pattern is suitable for collecting sounds produced to the right side or to the left side of a prescribed direction such as the forward direction, that is, sounds produced in the rightward and leftward directions, for example, when people present on the right and on the left are talking.

FIG. 4 shows an exemplary third direction pattern. The dotted arrow towards first directional microphone 45 shows the first directional direction. The dotted arrow towards second directional microphone 47 shows the second directional direction. In the third direction pattern, the first directional direction is a direction rotated clockwise by a prescribed angle from the first directional direction in the first direction pattern, and the second directional direction is a direction rotated counterclockwise by a prescribed angle from the second directional direction in the first direction pattern. Therefore, in the third direction pattern, first directional microphone 45 collects sounds produced to the left side from the top in the figure, and second directional microphone 47 collects sounds produced to the right side from the top in the figure. The directions of sounds collected in the third direction pattern are opposite to the directions of sounds collected by first directional microphone 45 and second directional microphone 47 in the second direction pattern. Therefore, a codec 31 described later internally processes such that a sound signal output by first directional microphone 45 is recorded as sound of the left channel Lch and a sound signal output by second directional microphone 47 is recorded as sound of the right channel Rch. The third direction pattern differs from the second direction pattern in that the range of source of sound that can be collected by first directional microphone 45 partially overlaps with the range of source of sound that can be collected by second directional microphone 47. Therefore, the localization of sound from the sound source in the overlapped range can be improved. Therefore, the third direction pattern is suitable for collecting sound produced to the right side or the left side from a prescribed direction such as the forward direction and, in addition, for collecting sound produced frontward with a sense of localization, for example, when a band is playing with a lead singer standing in the center. The third direction pattern is thus suitable for collecting sounds from the rightward and leftward directions and from the forward direction.

In the first embodiment, rotation axis 45A of first directional microphone 45 passes through first directional microphone 45, and rotation axis 47A of second directional microphone 47 passes through second directional microphone 47. However, rotation axis 45A of first directional microphone 45 and rotation axis 47A of second directional microphone 47 do not have to pass through first directional microphone 45 and second directional microphone 47 as long as they are parallel to each other.

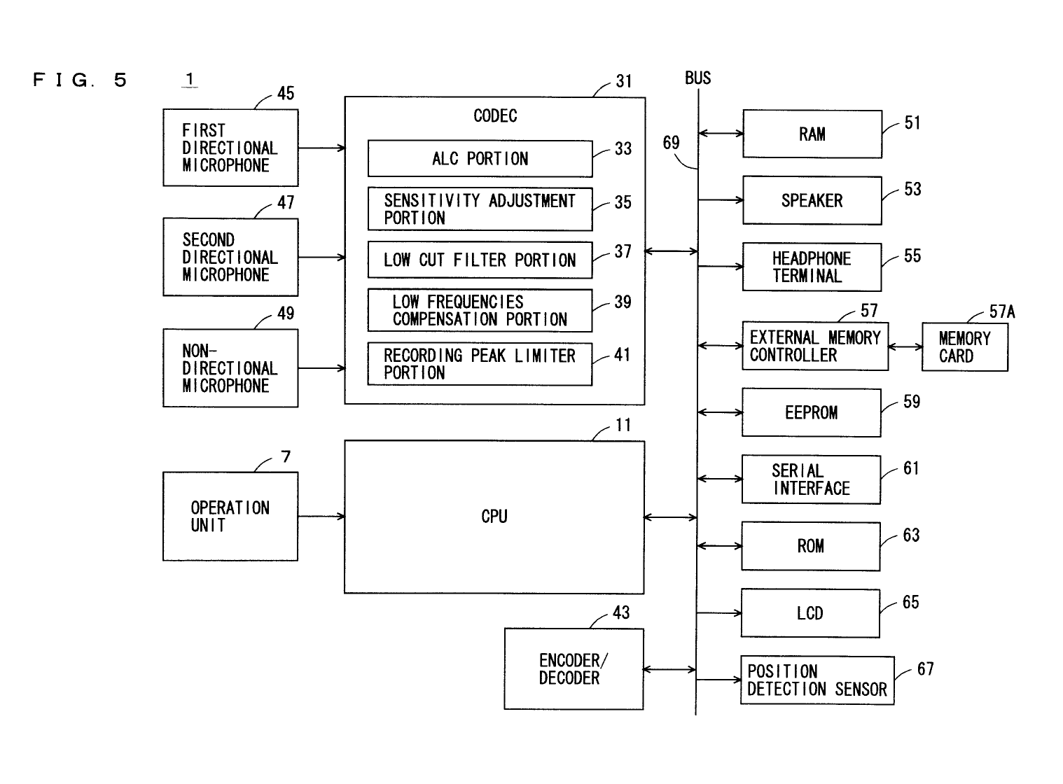

FIG. 5 is a functional block diagram showing an overall hardware configuration of the IC recorder. IC recorder 1 includes a Central Processing Unit (CPU) 11 for controlling the entire IC recorder 1, and codec 31, an encoder/decoder 43, a RAM (Random Access Memory) 51, a speaker 53, a headphone terminal 55, an external memory controller 57, an EEPROM (Electrically Erasable and Programmable Read Only Memory) 59, a serial interface (I/F) 61, a ROM 63, LCD 65, and a position detection sensor 67, each connected to CPU 11 via a bus 69.

RAM 51 is used as a work area of CPU 11. ROM 63 stores, for example, a program executed by CPU 11. EEPROM 59 is an internal memory for storing a compressed sound signal and the like in a nonvolatile manner. External memory controller 57 is connected with a memory card 57A. CPU 11 can access memory card 57A connected to external memory controller 57 through external memory controller 57.

Serial interface 61 is connected with a device capable of serial communication. CPU 11 can communicate with a device connected to serial interface 61 through serial interface 61. Headphone terminal 55 is connected with a headphone or an earphone to output an analog sound signal thereto. Speaker 53 receives input of an analog sound signal and outputs sound.

Codec 31 is connected with first directional microphone 45, second directional microphone 47, and non-directional microphone 49. Codec 31 converts analog sound signals input from first directional microphone 45 and second directional microphone 47 or analog sound signals input from first directional microphone 45, second directional microphone 47, and non-directional microphone 49 into a digital signal for a prescribed signal processing and outputs a digitally processed sound signal to CPU 11. The digitally processed sound signal is a two-channel audio signal of right and left channels.

Codec 31 includes, for processing a digital signal, an Auto Level Control (ALC) portion 33, a sensitivity adjustment portion 35, a low cut filter portion 37, a low frequencies compensation portion 39, and a recording peak limiter portion 41.

ALC portion 33 executes ALC processing based on an instruction from CPU 11 to automatically adjust the input level of a sound signal to be processed. For example, ALC portion 33 adjusts the input levels of high audio frequencies and low audio frequencies. Specifically, when an instruction to enable auto level control is input from CPU 11, ALC portion 33 adjusts the input level of a sound signal to be processed. When an instruction to disable auto level control is input, ALC portion 33 does not adjust the input level of a sound signal to be processed.

Sensitivity adjustment portion 35 executes microphone sensitivity adjustment processing based on an instruction from CPU 11 to adjust the respective sensitivities of first directional microphone 45, second directional microphone 47, and non-directional microphone 49 to high sensitivity or low sensitivity. Specifically, when an instruction to set high sensitivity is input from CPU 11, sensitivity adjustment portion 35 sets the respective sensitivities of first directional microphone 45, second directional microphone 47, and non-directional microphone 49 high. When an instruction to set low sensitivity is input, sensitivity adjustment portion 35 sets the respective sensitivities of first directional microphone 45, second directional microphone 47, and non-directional microphone 49 low.

Low cut filter portion 37 executes low cut filter processing based on an instruction from CPU 11 to cut sound in low frequencies of a sound signal to be processed. Specifically, when an instruction to enable the low cut filter is input from CPU 11, low cut filter portion 37 cuts sound at low frequencies of a sound signal to be processed. When an instruction to disable the low cut filter is input, low cut filter portion 37 does not cut sound at low frequencies of a sound signal to be processed.

Low frequencies compensation portion 39 executes low frequencies compensation processing based on an instruction from CPU 11 to compensate for the low frequencies in the audio frequency range of a sound signal to be processed. Specifically, when an instruction to enable low frequencies compensation is input from CPU 11, low frequencies compensation portion 39 compensates for the low frequencies of a sound signal to be processed. When an instruction to disable low frequencies compensation is input, low frequencies compensation portion 39 does not compensate for the low frequencies of a sound signal to be processed. When executing the low frequencies compensation processing, low frequencies compensation portion 39 compensates for the low frequencies by interpolating the low-frequency part of the sound signal output from each of first directional microphone 45 and second directional microphone 47 with the sound signal output from non-directional microphone 49. This is because first directional microphone 45 and second directional microphone 47 are characterized in that their sensitivity to low frequencies is lower than that of other frequencies. Low frequencies compensation portion 39 only outputs sound signals output from first directional microphone 45 and second directional microphone 47 when it does not execute the low frequencies compensation processing.

Recording peak limiter portion 41 executes recording peak limiter processing based on an instruction from CPU 11 to set the volume level of a sound signal to be processed to a prescribed value or lower. Specifically, when an instruction to enable recording peak limiter is input from CPU 11, recording peak limiter portion 41 sets the volume level of a sound signal to be processed to a prescribed value or lower. When an instruction to disable recording peak limiter is input, recording peak limiter portion 41 does not set the volume level of a sound signal to be processed to a prescribed value or lower.

Encoder/decoder 43 is controlled by CPU 11 to execute encoding processing of encoding a sound signal output from codec 31. Encoder/decoder 43 is also controlled by CPU 11 to execute decoding processing of decoding the encoded sound signal.

The sound signals output from first directional microphone 45, second directional microphone 47, and non-directional microphone 49 are converted into a digital signal by codec 31. CPU 11 allows encoder/decoder 43 to encode the sound signal output from codec 31 and stores the encoded sound signal into EEPROM 59 or memory card 57A connected to external memory controller 57. CPU 11 reads out the sound signal stored in EEPROM 59 or memory card 57A connected to external memory controller 57, allows encoder/decoder 43 to decode the signal, allows codec 31 to convert the decoded sound signal into an analog signal, and outputs the analog audio signal to speaker 53 or a headphone connected to headphone terminal 55.

Position detection sensor 67 detects a position of dial 25 and outputs the detected position to CPU 11. Position detection sensor 67 is, for example, a proximity switch and detects in which of the first position, the second position, and the third position dial 25 is set. Specifically, position detection sensor 67 outputs a first detection signal to CPU 11 when detecting that dial 25 is positioned in the first position, outputs a second detection signal to CPU 11 when dial 25 is positioned in the second position, and outputs a third detection signal to CPU 11 when dial 25 is positioned in the third position. Position detection sensor 67 may be an encoder.

In the first embodiment, CPU 11 executes a program stored in ROM 63, by way of example. However, CPU 11 may execute a program stored in EEPROM 59 or memory card 57A connected to external memory controller 57.

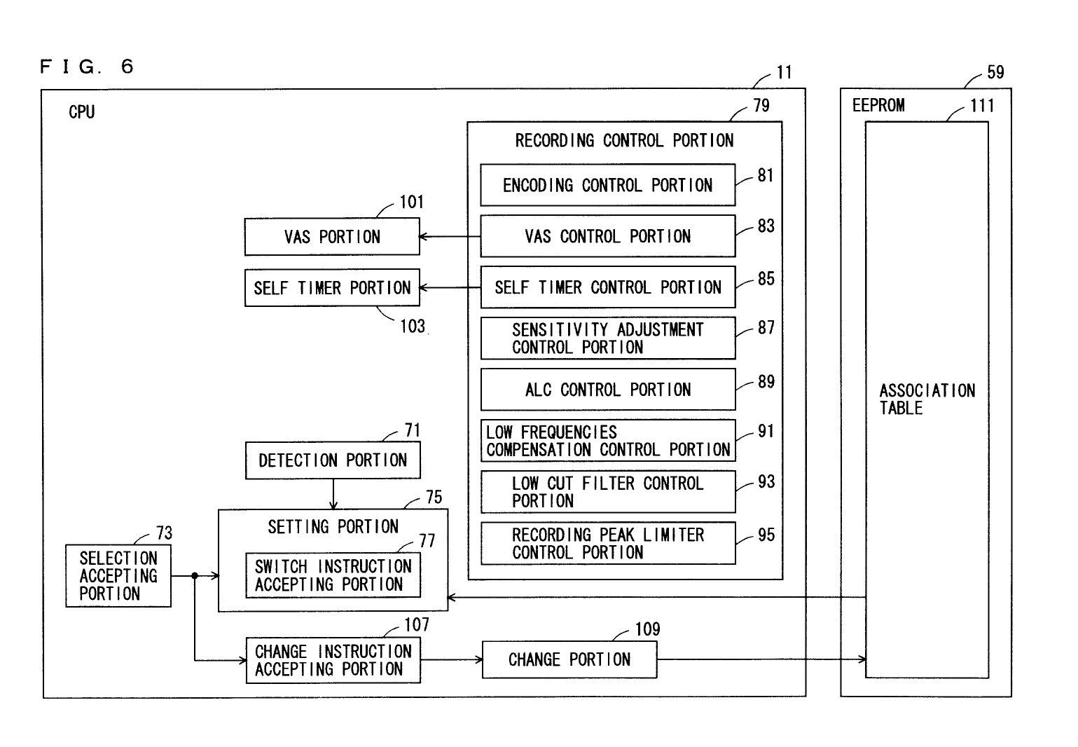

FIG. 6 is a functional block diagram showing an overall function of CPU together with data stored in EEPROM in the first embodiment. The functions shown in FIG. 6 are formed in CPU 11 when CPU 11 executes a program stored in ROM 63, EEPROM 59 or memory card 57A. CPU 11 includes a detection portion 71 detecting a direction pattern, a selection accepting portion 73 accepting a selection of a scene by the user, a setting portion 75 setting recording conditions, a recording control portion 79, a change instruction accepting portion 107, a change portion 109, a VAS (Voice Active System) portion 101, and a self-timer portion 103.

VAS portion 101 is controlled by a VAS control portion 83 described later and executes VAS processing of cutting a silent portion of a sound signal to be processed. VAS portion 101 executes the VAS processing when an instruction to enable the VAS processing is input from VAS control portion 83. VAS portion 101 does not execute the VAS processing when an instruction to disable the VAS processing is input.

Self-timer portion 103 is controlled by a self-timer control portion 85 described later and executes self-timer processing in which recording is started at a predetermined time after the user presses record button 15 to make ready for recording. Self-timer portion 103 execute the self-timer processing when an instruction to enable the self-timer processing is input from self-timer control portion 85. Self-timer portion 103 does not execute the self-timer processing when an instruction to disable the self-timer processing is input.

Detection portion 71 detects switching of the direction patterns based on an output from position detection sensor 67. As described above, as the user rotates dial 25, the first directional direction and the second directional direction are changed in connection with the rotation of dial 25 to switch to any one of the first direction pattern, the second direction pattern, and the third direction pattern. The first direction pattern corresponds to the state in which dial 25 is in the first position. The second direction pattern corresponds to the state in which dial 25 is in the second position. The third direction pattern corresponds to the state in which dial 25 is in the third position. Therefore, when the output of position detection sensor 67 changes to the first detection signal, detection portion 71 detects the first direction pattern and outputs a first switching signal to setting portion 75 to indicate the switching to the first direction pattern. When the output of position detection sensor 67 changes to the second detection signal, detection portion 71 detects the second direction pattern and outputs a second switching signal to setting portion 75 to indicate the switching to the second direction pattern. When the output of position detection sensor 67 changes to the third detection signal, detection portion 71 detects the third direction pattern and outputs a third switching signal to setting portion 75 to indicate the switching to the third direction pattern.

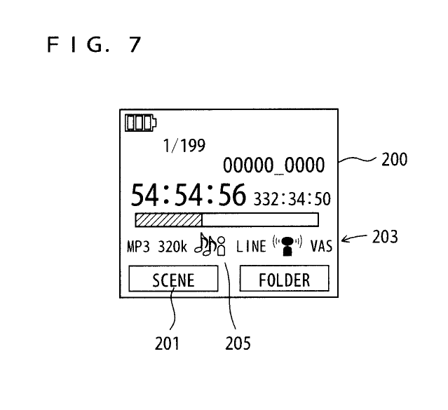

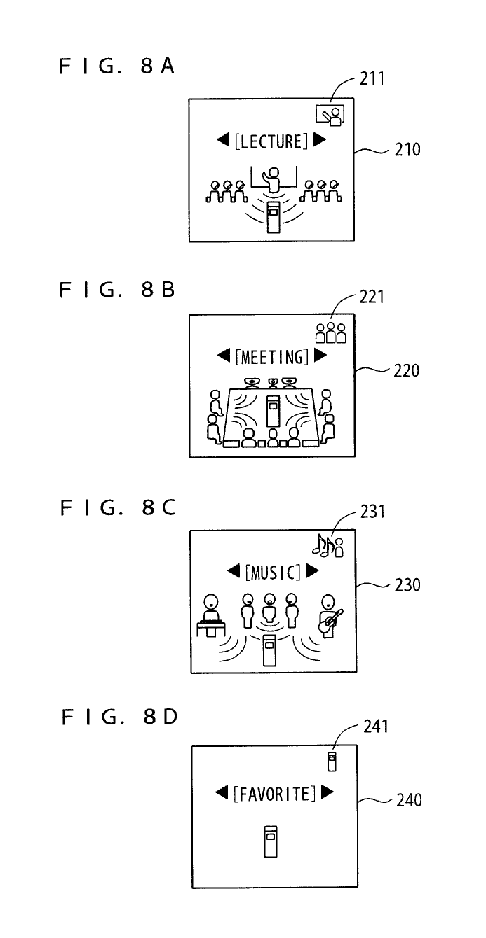

Selection accepting portion 73 displays a basic screen on LCD 65 and accepts a scene selection instruction. FIG. 7 shows an exemplary basic screen. A basic screen 200 is a screen initially appearing on LCD 65 at power-on. Basic screen 200 includes a region 203 displaying part of set parameters and a scene button 201. Scene button 201 corresponds to first function button 9. Region 203 includes an icon 205 allocated to the selected scene. Here, icon 205 is the same as an icon 231 (see FIG. 8C) allocated to a scene having the scene name “Music” to indicate that the scene having the scene name “Music” is selected. Therefore, the user looks at icon 205 in basic screen 200 and recognizes the selected scene. Furthermore, since first directional microphone 45 and second directional microphone 47 are arranged above LCD 65 as shown in FIG. 1, the user can visually identify basic screen 200 on LCD 65 as well as first directional microphone 45 and second directional microphone 47 at the same time. Accordingly, the user can confirm the direction pattern of first directional microphone 45 and second directional microphone 47 and the set parameters at the same time.

Returning to FIG. 6, when the user presses first function button 9 while basic screen 200 is being displayed on LCD 65, selection accepting portion 73 accepts a scene display instruction and displays four scene select screens corresponding to four scenes in order on LCD 65. Three of the four scenes include a “lecture” scene, a “meeting” scene, and a “music” scene. The “lecture” scene is a scene in which sound from the forward direction is recorded, for example, in the case where a person speaks in front of people. The “meeting” scene is a scene in which sounds from all the directions are recorded in the case where people are talking. The “music” scene is a scene in which music performance or animal voice is recorded in high sound quality. The remaining one of the four scenes is a scene “favorite” created according to the user's preference. Although the first embodiment illustrates four scenes by way of example, the number of scenes is not limited thereto and may be five or more, for example, with more favorite scenes, or may be less than four.

FIG. 8A to FIG. 8D each show an exemplary scene select screen. FIG. 8A shows a scene select screen corresponding to the “lecture” scene. A scene select screen 210 includes a character string “LECTURE,” a picture depicting a lecture in which a person is speaking in front of people, and an icon 211 allocated to the scene having the scene name “Lecture.” FIG. 8B shows a scene select screen corresponding to the “meeting” scene. A scene select screen 220 includes a character string “MEETING,” a picture depicting a meeting in which people are talking, and an icon 221 allocated to the scene having the scene name “Meeting.” FIG. 8C shows a scene select screen corresponding to the “music” scene. A scene select screen 230 includes a character string “MUSIC,” a picture depicting music performance, and an icon 231 allocated to the scene having the scene name “Music.” FIG. 8D shows a scene select screen corresponding to the “favorite” scene. A scene select screen 240 includes a character string “FAVORITE,” a picture allocated to the scene having the scene name “Favorite,” and an icon 241 allocated to the scene having the scene name “Favorite.” Any one of four scene select screens 210, 220, 230, and 240 appears on LCD 65, and the scene select screens appearing on LCD 65 are switched in order when the user presses right button 17C or left button 17D.

When the user operates control button 17 to switch the scene select screens in order and presses OK button 19, selection accepting portion 73 accepts a scene select instruction to select the scene corresponding to the scene select screen displayed at the time when OK button 19 is selected, among the four scene select screens. When accepting the scene select instruction, select accepting portion 73 outputs, to setting portion 75 and change instruction accepting portion 107, the scene name for identifying the scene corresponding to the scene select screen displayed at the time when OK button 19 is pressed, among the four scene select screens.

Setting portion 75 receives any one of first to third switching signals from detection portion 71 and receives a scene name from selection accepting portion 73. When a scene name is input from selection accepting portion 73, setting portion 75 sets, as a plurality of parameters for executing plural kinds of processing, a plurality of parameters corresponding to predetermined plural kinds of processing which are associated with the scene specified by the scene name by an association table stored in EEPROM 59. A plurality of parameters for executing plural kinds of processing are recording conditions. The plural kinds of processing include the encoding processing executed by encoder/decoder 43, the ALC processing executed by ACL portion 33, the microphone sensitivity adjustment processing executed by sensitivity adjustment portion 35, the low cut filter processing executed by low cut filter portion 37, the low frequencies compensation processing executed by low frequencies compensation portion 39, the recording peak limiter processing executed by recording peak limiter portion 41, the VAS processing executed by VAS portion 101, and the self-timer processing executed by self-timer portion 103.

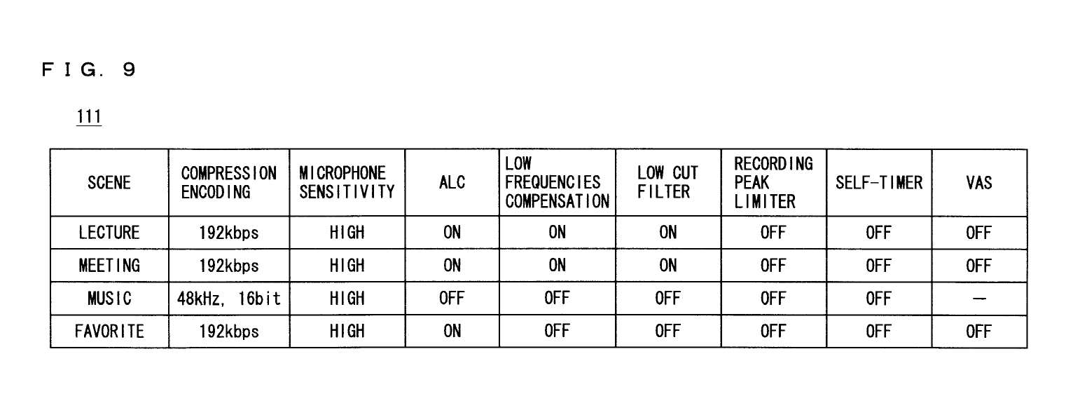

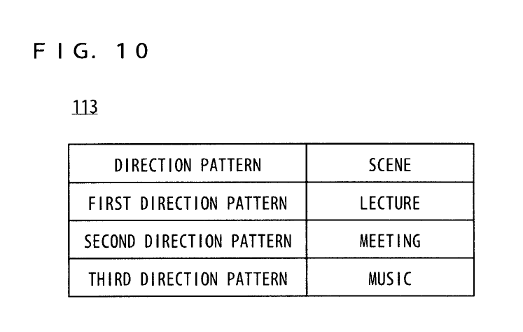

FIG. 9 shows an exemplary association table. An association table 111 includes four association records corresponding to the four scenes, in each of which the scene name is associated with a plurality of parameters for executing the plural kinds of processing. The association record includes an item of scene, an item of compression encoding, an item of microphone sensitivity, an item of ALC, an item of low frequencies compensation, an item of low cut filter, an item of recording peak limiter, an item of self-timer, and an item of VAC. In the item of scene, any one of the four scenes corresponding to the scene names “Lecture,” “Meeting,” “Music,” and “Favorite” is set. In association table 111 here, a scene that can be set by the user is only the “favorite” scene. However, two or more scenes may be provided, similar to the “favorite” scene, in which the user can set a plurality of parameters for executing the plural kinds of processing. In such a case, association table 111 includes five or more association records.

In the item of compression encoding in the association record, any one of 16 bit, 44 kHz/48 kHz/320 kbps/192 kbps/64 kbps/32 kbps representing compression rates is set as a parameter used to execute encoding processing. In the item of microphone sensitivity, Low or High indicating high or low microphone sensitivity is set as a parameter to be used to execute the microphone sensitivity adjustment processing. In the item of ALC, ON or OFF indicating whether or not to execute the ALC processing is set as a parameter to be used to execute the ALC processing. In the item of low frequencies compensation, ON or OFF indicating whether or not to execute the low frequencies compensation processing is set as a parameter to be used to execute the low frequencies compensation processing. In the item of low cut filter, ON or OFF indicating whether or not to execute the low cut filter processing is set as a parameter to be used to execute the low cut filter processing. In the item of recording peak limiter, ON or OFF indicating whether or not to execute the recording peak limiter processing is set as a parameter to be used to execute the recording peak limiter processing. In the item of self-timer, ON or OFF indicating whether or not to execute the self-timer processing is set as a parameter to be used to execute the self-timer processing. In the item of VAS, ON or OFF indicating whether or not to execute the VAS processing is set as a parameter to be used to execute the VAS processing.

For example, in the association record in which “lecture” is set in the item of scene, a parameter “192 kbps” is set in the item of compression encoding, a parameter “High” is set in the item of microphone sensitivity, a parameter “ON” is set in the item of ALC, a parameter “ON” is set in the item of low frequencies compensation, a parameter “ON” is set in the item of low cut filter, a parameter “ON” is set in the item of recording peak limiter, a parameter “OFF” is set in the item of self-timer, and a parameter “OFF” is set in the item of VAS.

Returning to FIG. 6, when the scene name input from selection accepting portion 73 is input, setting portion 75 extracts an association record in which the scene name input from selection accepting portion 73 is set in the item of scene, from the four association records included in association table 111 stored in EEPROM 59. Setting portion 75 stores a plurality of parameters corresponding to the plural kinds of processing included in the extracted association record, as recording conditions for executing the plural kinds of processing, into EEPROM 59. Specifically, stored as the recording conditions in EEPROM 59 are the parameter to be used to execute the encoding processing, the parameter to be used to execute the microphone sensitivity adjustment processing, the parameter to be used to execute the ALC processing, the parameter to be used to execute the low frequencies compensation processing, the parameter to be used to execute the low cut filter processing, the parameter to be used to execute the recording peak limiter processing, the parameter to be used to execute the self-timer processing, and the parameter to be used to execute the VAS processing. It is noted that if a plurality of parameters have already been stored as recording conditions in EEPROM 59, the plurality of parameters stored as the recording conditions are overwritten.

Setting portion 75 includes a switching instruction accepting portion 77. Switching instruction accepting portion 77 accepts a switching instruction to switch recording conditions when one of the first to third switching signals is input from detection portion 71. When the first switching signal is input, switching instruction accepting portion 77 determines that the switching to the first direction pattern is done. When the second switching signal is input, switching instruction accepting portion 77 determines that the switching to the second direction pattern is done. When the third switching signal is input, switching instruction accepting portion 77 determines that the switching to the third direction pattern is done. Then, switching instruction accepting portion 77 specifies a predetermined scene corresponding to the one of the first to third direction patterns that is determined by the first to third switching signals input from detection portion 71, using a direction pattern table stored beforehand in EEPROM 59.

FIG. 10 shows an exemplary direction pattern table. A direction pattern table 113 includes three direction pattern records corresponding to three direction patterns, in which three direction patterns are each related with one of three scenes. The direction pattern record includes the item of direction pattern and the item of scene. A direction pattern name is set in the item of direction pattern, and a scene name is set in the item of scene. The direction pattern name “the first direction pattern” is related with the scene name “Lecture.” The first direction pattern is related with the scene name “Lecture” because the first direction pattern is suitable for recording in the “lecture” scene. The direction pattern name “the second direction pattern” is related with the scene name “Meeting.” The second direction pattern is related with the scene name “Meeting” because the second direction pattern is suitable for recording in the “meeting” scene. The direction pattern name “the third direction pattern” is related with the scene name “Music.” The third direction pattern is related with the scene “Music” because the third direction pattern is suitable for recording in the “music” scene.

Switching instruction accepting portion 77 refers to direction pattern table 113 to specify the scene corresponding to the one of the first to third switching signals that is input from detection portion 71 and then displays a recommended scene determination screen corresponding to the specified scene on LCD 65. When the first switching signal is input from detection portion 71, switching instruction accepting portion 77 displays a first recommended scene determination screen corresponding to the scene “lecture.” When the second switching signal is input from detection portion 71, switching instruction accepting portion 77 displays a second recommended scene determination screen corresponding to the scene “meeting.” When the third switching signal is input from detection portion 71, switching instruction accepting portion 77 displays a third recommended scene determination screen corresponding to the scene “music.”

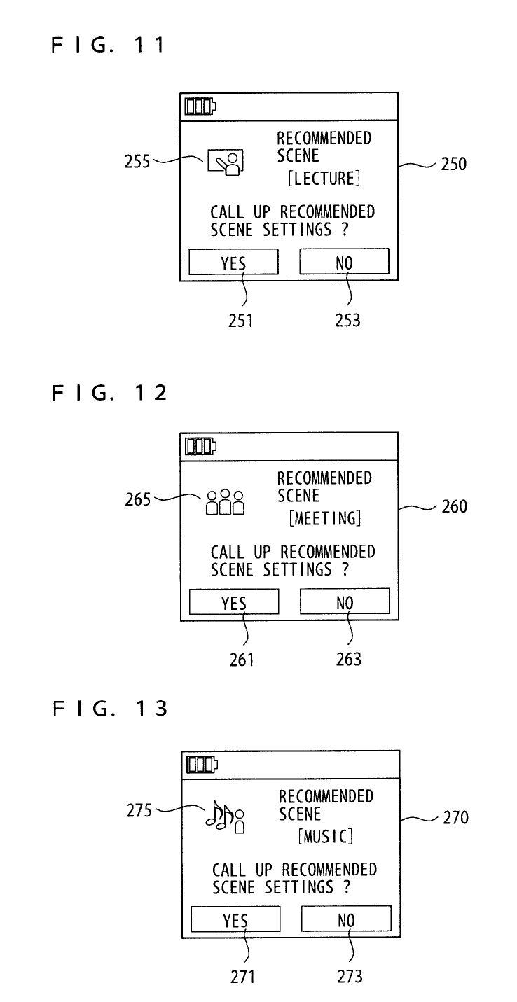

FIG. 11 shows an exemplary first recommended scene determination screen. A first recommended scene determination screen 250 includes an icon 255 allocated to the scene having the scene name “Lecture,” a character string “Recommended Scene [Lecture],” a character string “Call up recommended scene settings?,” an OK key 251 including a character string “YES,” and a cancel key 253 including a character string “NO.” OK key 251 corresponds to first function button 9, and cancel key 253 corresponds to second function button 10. When the user presses first function button 9, the scene having the scene name “Lecture” is determined. When the user presses second function button 10, the scene having the scene name “Lecture” is not determined. Icon 255 allocated to the scene having the scene name “Lecture” is the same as icon 211 included in scene select screen 210 shown in FIG. 8A. Therefore, the user can look at first recommended scene determination screen 250 to confirm that the parameters corresponding to the scene having the scene name “Lecture” are to be set.

FIG. 12 shows an exemplary second recommended scene determination screen. A second recommended scene determination screen 260 includes an icon 265 allocated to the scene having the scene name “Meeting,” a character string “Recommended Scene [Meeting],” a character string “Call up recommended scene settings?,” an OK key 261 including a character string “YES,” and a cancel key 263 including a character string “NO.” OK key 261 corresponds to first function button 9, and cancel key 263 corresponds to second function button 10. When the user presses first function button 9, the scene having the scene name “Meeting” is determined. When the user presses second function button 10, the scene having the scene name “Meeting” is not determined. Icon 265 allocated to the scene having the scene name “Meeting” is the same as icon 221 included in scene select screen 220 shown in FIG. 8B.

Therefore, the user can look at second recommended scene determination screen 260 to confirm that the parameters corresponding to the scene having the scene name “Meeting” are to be set.

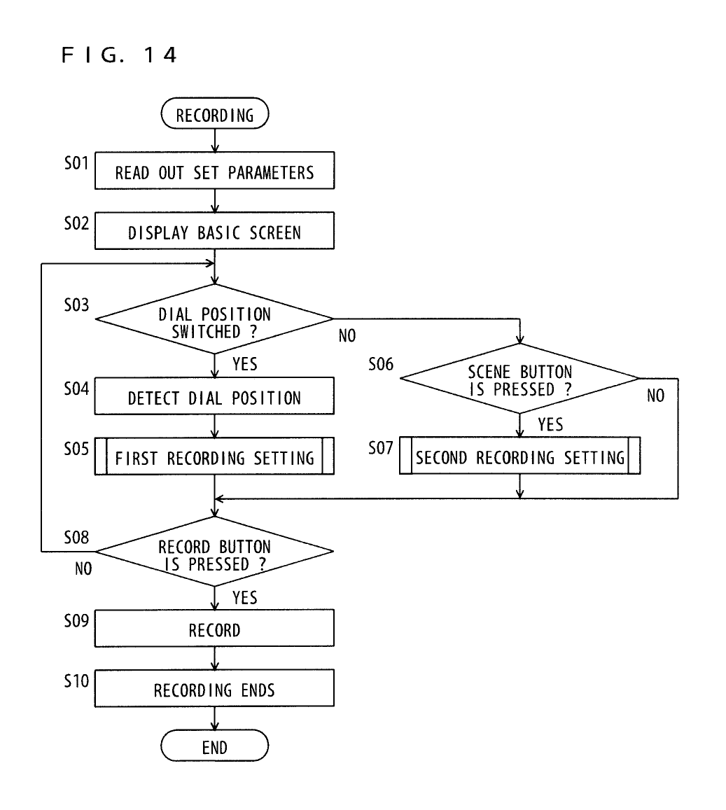

FIG. 13 shows an exemplary third recommended scene determination screen. A third recommended scene determination screen 270 includes an icon 275 allocated to the scene having the scene name “Music,” a character string “Recommended Scene [Music],” a character string “Call up recommended scene settings?,” an OK key 271 including a character string “YES,” and a cancel key 273 including a character string “NO.” OK key 271 corresponds to first function button 9, and cancel key 273 corresponds to second function button 10. When the user presses first function button 9, the scene having the scene name “Music” is determined. When the user presses second function button 10, the scene having the scene name “Music” is not determined. Icon 275 allocated to the scene having the scene name “Music” is the same as icon 231 included in scene select screen 230 shown in FIG. 8C.

Therefore, the user can look at third recommended scene determination screen 270 to confirm that the parameters corresponding to the scene having the scene name “Music” are to be set.

Returning to FIG. 6, switching instruction accepting portion 77 accepts a switching instruction when the user presses first function button 9 while one of the first to third recommended scene determination screen is being displayed on LCD 65. The switching instruction is an instruction to switch the recording conditions to a plurality of parameters for executing the plural kinds of processing defined by association table 111 in accordance with the specified scene. When first function button 9 is pressed while the first recommended scene determination screen is being displayed on LCD 65, the switching instruction specifies the scene name “Lecture.” When first function button 9 is pressed while the second recommended scene determination screen is being displayed on LCD 65, the switching instruction specifies the scene name “Meeting.” When first function button 9 is pressed while the third recommended scene determination screen is being displayed on LCD 65, the switching instruction specifies the scene name “Music.”

When switching instruction accepting portion 77 accepts the switching instruction, setting portion 75 extracts the association record in which the scene name of the scene specified by the switching instruction is set in the item of scene, from the four association records included in association table 111 stored in ROM 63. Setting portion 75 stores a plurality of parameters corresponding to plural kinds of processing included in the extracted association record, as recording conditions, into EEPROM 59. If a plurality of parameters have already been stored as recording conditions in EEPROM 59, the stored plurality of parameters are overwritten.

The user operates dial 25 to switch dial 25 to one of the first position, the second position, and the third position, so that one of the first to third direction patterns is determined, and a plurality of predetermined parameters are set as recording conditions corresponding to the predetermined scene for the determined one of the first to third direction patterns. Accordingly, the recording conditions can be set through the simple operation of rotating dial 25 to switch the direction patterns.

On the other hand, when the user operates control button 17 to select one of the four scene select screens and presses OK button 19, a plurality of predetermined parameters are set as recording conditions corresponding to the scene corresponding to the scene select screen displayed at the time when OK button 19 is pressed, among the four scene select screens. Therefore, the user can set recording conditions irrespective of a direction pattern which defines a set of the respective directional directions of first directional microphone 45 and second directional microphone 47. Therefore, any one of predetermined four scenes can be combined with any one of the first to third direction patterns, and recording can be performed under a plurality of conditions.

Codec 31, encoder/decoder 43, VAS portion 101, and self-timer portion 103 constitute a recording unit, which performs plural kinds of processing on the sound output by first directional microphone 45 and second directional microphone 47 and records the processed sound. Recording control portion 79 controls and allows the recording unit to perform a plurality of processing and stores the processed sound into EEPROM 59. Recording control portion 79 includes an encoding control portion 81, a VAS control portion 83, a self-timer control portion 85, a sensitivity adjustment control portion 87, an ALC control portion 89, a low frequencies compensation control portion 91, a low cut filter control portion 93, and a recording peak limiter control portion 95.

Encoding control portion 81 reads out the parameter to be used to execute the compression encoding processing, among a plurality of parameters for executing plural kinds of processing that are stored as recording conditions in EEPROM 59, and controls encoder/decoder 43 such that encoder/decoder 43 executes the processing of compressing a sound signal at a bit rate determined by the read parameter.

VAS control portion 83 reads out the parameter to be used to execute the VAS processing among a plurality of parameters for executing plural kinds of processing that are stored as recording conditions in EEPROM 59. When the read parameter indicates “ON,” VAS control portion 83 allows VAS portion 101 to execute the VAS processing so that a sound signal of a silent portion is cut. When the read parameter indicates “OFF,” VAS control portion 83 does not allow VAS portion 101 to execute the VAS processing.

Self-timer control portion 85 reads out the parameter to be used to execute the self-timer processing among a plurality of parameters for executing plural kinds of processing that are stored as recording conditions in EEPROM 59. When the read parameter indicates “ON,” self-timer control portion 85 outputs an instruction to enable the self-timer processing to self-timer portion 103 and allows self-timer portion 103 to execute the self-timer processing. When the read parameter indicates “OFF,” self-timer control portion 85 outputs an instruction to disable the self-timer processing to self-timer portion 103 and does not allow self-timer portion 103 to execute the self-timer processing.

Sensitivity adjustment control portion 87 reads out the parameter to be used to execute the microphone sensitivity adjustment processing among a plurality of parameters for executing plural kinds of processing that are stored as recording conditions in EEPROM 59. When the read parameter indicates “high,” sensitivity adjustment control portion 87 outputs an instruction to set high sensitivity to sensitivity adjustment portion 35 and allows sensitivity adjustment portion 35 to adjust the respective sensitivities of first directional microphone 45, second directional microphone 47, and non-directional microphone 49 to high sensitivity. When the read parameter of microphone sensitivity indicates “low,” sensitivity adjustment control portion 87 outputs an instruction to set low sensitivity to sensitivity adjustment portion 35 and allows sensitivity adjustment portion 35 to adjust the respective sensitivities of first directional microphone 45, second directional microphone 47, and non-directional microphone 49 to low sensitivity.

ALC control portion 89 reads out the parameter to be used to execute the ALC processing among a plurality of parameters for executing plural kinds of processing that are stored as recording conditions in EEPROM 59. When the read parameter indicates “ON,” ALC control portion 89 outputs an instruction to enable auto level control to ALC portion 33 and allows ALC portion 33 to adjust the input level of sound. When the read parameter indicates “OFF,” ALC control portion 89 outputs an instruction to disable auto level control to ALC portion 33 and does not allow ALC portion 33 to adjust the input level of sound.

Low frequencies compensation control portion 91 reads out the parameter to be used to execute the low frequencies compensation processing among a plurality of parameters for executing plural kinds of processing that are stored as recording conditions in EEPROM 59. When the read parameter indicates “ON,” low frequencies compensation control portion 91 outputs an instruction to enable low frequencies compensation to low frequencies compensation portion 39 and allows low frequencies compensation portion 39 to compensate for the low-frequency portion of a sound signal. When the read parameter indicates “OFF,” low frequencies compensation control portion 91 outputs an instruction to disable low frequencies compensation to low frequencies compensation portion 39 and does not allow low frequencies compensation portion 39 to compensate for the low-frequency portion of a sound signal.

Low cut filter control portion 93 reads out the parameter to be used to execute the low cut filter processing among a plurality of parameters for executing plural kinds of processing that are stored as recording conditions in EEPROM 59. When the read parameter indicates “ON,” low cut filter control portion 93 outputs an instruction to enable low cut filter to low cut filter portion 37 and allows low cut filter portion 37 to cut the sound at low frequencies. When the read parameter indicates “OFF,” low cut filter control portion 93 outputs an instruction to disable low cut filter to low cut filter portion 37 and does not allow low cut filter portion 37 to cut the sound at low frequencies.

Recording peak limiter control portion 95 reads out the parameter to be used to execute the recording peak limiter processing among a plurality of parameters for executing plural kinds of processing that are stored as recording conditions in EEPROM 59. When the read parameter indicates “ON,” recording peak limiter control portion 95 outputs an instruction to enable recording peak limiter to recording peak limiter portion 41 and allows recording peak limiter portion 41 to set the volume level to a prescribed value or lower. When the read parameter indicates “OFF,” recording peak limiter control portion 95 outputs an instruction to disable recording peak limiter to recording peak limiter portion 41 and does not allow recording peak limiter portion 41 to adjust the volume level.

Change instruction accepting portion 107 receives a scene name from selection accepting portion 73. Change instruction accepting portion 107 accepts a setting change instruction when the user operates operation unit 7 to input an instruction to change the settings of parameters. When accepting the setting change instruction, change instruction accepting portion 107 reads out an association record in which the scene name input from selection accepting portion 73 is set in the item of scene, from association table 111 stored in EEPROM 59. Change instruction accepting portion 107 displays, on LCD 65, a parameter setting edit list screen for changing plural kinds of parameters set in the read association record.

The parameter setting edit list screen is a screen including the names of plural kinds of parameters and the plural kinds of parameters, for accepting a change of parameters. In the parameter setting edit list screen, the user can designate a parameter name and change the parameter corresponding to the designated parameter name by operating operation unit 7.

When the user operates operation unit 7 and presses OK button 19 while the parameter setting edit list screen is being displayed on LCD 65, change instruction accepting portion 107 outputs the scene name input from selection accepting portion 73 and a set of the name of the changed parameter and the changed parameter to change portion 109.

Change portion 109 receives the scene name and a set of the parameter name and the parameter from change instruction accepting portion 107.

Change portion 109 changes the association record in which the scene name input from change instruction accepting portion 107 is set in the item of scene, among a plurality of association records included in association table 111 stored in EEPROM 59, based on the set of the name of the changed parameter and the changed parameter. Accordingly, association table 111 is updated.

The user can change association table 111 and thus can set parameters as suited for the user's usage.

FIG. 14 is a flowchart showing an exemplary flow of a recording process. The recording process is a process executed by CPU 11 executing a recording condition setting program stored in ROM 63, EEPROM 59, or memory card 57A. CPU 11 reads out plural kinds of parameters already stored as recording conditions in EEPROM 59 (step S01).

In the next step S02, basic screen 200 shown in FIG. 7 is displayed on LCD 65. Then, in step S03, it is determined whether the position of dial 25 is switched. Whether the position of dial 25 is switched is determined based on the output from position detection sensor 67. If it is determined that the position of dial 25 is switched, the process proceeds to step S04. If not, the process proceeds to step S06.

In step S04, the position of dial 25 switched in step S03 is detected. In the next step S05, a first recording setting process is executed, and the process proceeds to step S08. The first recording setting process will be described later. On the other hand, in step S06, it is determined whether the scene button is pressed. If first function button 9 corresponding to scene button 201 included in basic screen 200 shown in FIG. 7 is pressed, it is determined that the scene button is pressed. If the scene button is pressed, the process proceeds to step S07. If not, the process proceeds to step S08. In step S07, a second recording setting process is executed, and the process proceeds to step S08. The second recording setting process will be described later.

In step S08, it is determined whether record button 15 is pressed. If record button 15 is pressed, the process proceeds to step S09. If not, the process returns to step S03. In step S09, recording is started. In this case, recording is performed in such a manner that a sound signal subjected to a plurality of processing using plural kinds of parameters stored as recording conditions in EEPROM 59 is stored into EEPROM 59. When step S05 and step S07 are not executed, a plurality of processing is executed in accordance with the parameters read out in step S01. When step S05 is executed, a plurality of processing is executed in accordance with the parameters set in the first recording setting process described later. When step S07 is executed, a plurality of processing is executed in accordance with the parameters set in the second recording process described later. In the next step S10, when the user presses stop button 13, the recording is ended. The recording process then ends.

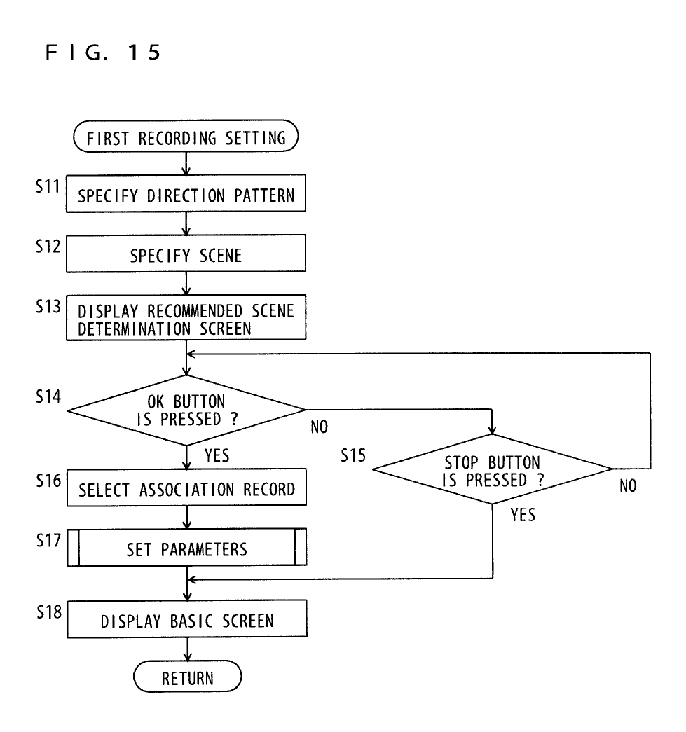

FIG. 15 is a flowchart showing an exemplary flow of the first recording setting process. The first recording setting process is a process executed in step S05 in FIG. 14. In step S11, the direction pattern corresponding to the position of dial 25 detected in step S04 in FIG. 14 is specified. In the next step S12, the scene corresponding to the direction pattern specified in step S11 is specified. The scene related with the direction pattern specified in step S11 is specified in direction pattern table 113 stored in ROM 63.

In the next step S13, the recommended scene determination screen corresponding to the scene specified in step S12 is displayed on LCD 65. When the scene having the scene name “Lecture” is specified in step S12, first recommended scene determination screen 250 shown in FIG. 11 is displayed on LCD 65. When the scene having the scene name “Meeting” is specified in step S12, second recommended scene determination screen 260 shown in FIG. 12 is displayed on LCD 65. When the scene having the scene name “Music” is specified in step S12, third recommended scene determination screen 270 shown in FIG. 13 is displayed on LCD 65.

In the next step S14, it is determined whether OK button 19 is pressed. If OK button 19 is pressed, the process proceeds to step S16. If not, the process proceeds to step S15. In step S15, it is determined whether stop button 13 is pressed. If stop button 13 is pressed, the process proceeds to step S18. If not, the process returns to step S14.

In step S16, an association record in which the scene name of the scene specified in step S12 is set in the item of scene is selected from among the four association records included in association table 111 stored in EEPROM 59. In the next step S17, a parameter setting process is executed, and the process proceeds to step S18. The parameter setting process will be described later. In step S18, basic screen 200 is displayed on LCD 65, and the process returns to the recording process.

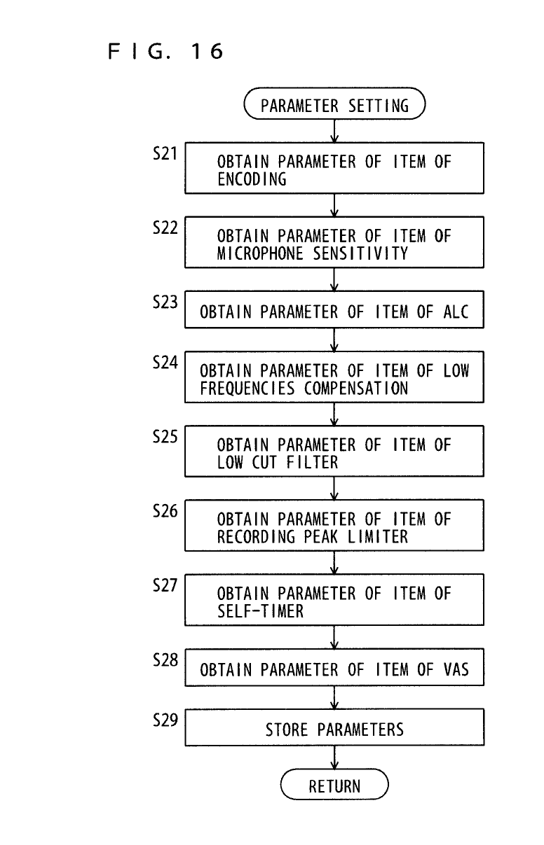

FIG. 16 is a flowchart showing an exemplary flow of the parameter setting process. The parameter setting process is a process executed in each of step S17 in FIG. 15 and step S35 in FIG. 17 described later. When this process is executed in step S17 in FIG. 15, the association record selected in step S16 in FIG. 15 is set as a process target. In step S21, the parameter set in the item of compression encoding in the association record is obtained as a parameter to be used to execute the encoding processing. In step S22, the parameter set in the item of microphone sensitivity is obtained as a parameter to be used to execute the microphone sensitivity adjustment processing. In step S23, the parameter set in the item of ALC in the association record is obtained as a parameter to be used to execute the ALC processing. In step S24, the parameter set in the item of low frequencies compensation in the association record is obtained as a parameter to be used to execute the low frequencies compensation processing. In step S25, the parameter set in the item of low cut filter in the association record is obtained as a parameter to be used to execute the low cut filter processing. In step S26, the parameter set in the item of recording peak limiter in the association record is obtained as a parameter to be used to execute the recording peak limiter processing. In step S27, the parameter set in the item of self-timer in the association record is obtained as a parameter to be used to execute the self-timer processing. In step S28, the parameter set in the item of VAS in the association record is obtained as a parameter to be used to execute the VAS processing.

In the next step S29, the parameters obtained in step S21 to step S28 are stored as recording conditions into EEPROM 59. The process then returns to the first recording setting process. Thus, the parameters defined by the association record selected in step S16 in FIG. 15 are set as parameters for executing the encoding processing, the microphone sensitivity adjustment processing, the ALC processing, the low frequencies compensation processing, the low cut filter processing, the recording peak limiter processing, the self-timer processing, and the VAS processing.

FIG. 17 is a flowchart showing an exemplary flow of the second recording setting process. The second recording setting process is a process executed in step S07 in FIG. 14. In step S31, association table 111 stored in EEPROM 59 is read out. In the next step S32, the four scene select screens are displayed one by one in order on LCD 65. Specifically, any one of the four scene select screens shown in FIG. 8A to FIG. 8D is displayed on LCD 65, and every time the user presses right button 17C or left button 17D of control button 17, the screen is switched to another scene select screen.

In the next step S33, it is determined whether the user selects a scene. When pressing of OK button 19 is detected, a scene is selected. If a scene is selected, the process proceeds to step S34. If not, the process returns to step S32. Among the four scene select screens, selected is a scene that corresponds to the scene select screen displayed on LCD 65 at the time when pressing of OK button 19 is detected.

In step S34, an association record in which the scene name of the scene selected in step S33 is set in the item of scene is selected from the four association records included in association table 111 read out in step S31. In the next step S35, the parameter setting process shown in FIG. 16 is executed, and the process proceeds to step S36. The association record selected in step S34 is set as a process target in the parameter setting process executed in step S35. In step S36, basic screen 200 is displayed on LCD 65, and the process returns to the recording process.

As a result of execution of the parameter setting process in step S35, the parameters defined by the association record selected in step S34 are set as parameters for executing the encoding processing, the microphone sensitivity adjustment processing, the ALC processing, the low frequencies compensation processing, the low cut filter processing, the recording peak limiter processing, the self-timer processing, and the VAS processing.

As described above, when the user rotates dial 25 to switch the directional directions of first directional microphone 45 and second directional microphone 47 to one of the predetermined first to third direction patterns, IC recorder 1 in the first embodiment detects the switched direction pattern from the first to third direction patterns. Then, for the sounds output by first directional microphone 45 and second directional microphone 47, a plurality of parameters to be used to execute plural kinds of processing including the encoding processing, the microphone sensitivity adjustment processing, the ALC processing, the low frequencies compensation processing, the low cut filter processing, the recording peak limiter processing, the self-timer processing, and the VAS processing are set as parameters for the plural kinds of processing that are associated with the detected one of the first to third direction patterns by association table 111. Therefore, the parameters to be used to execute plural kinds of processing can be set for the sounds output by first directional microphone 45 and second directional microphone 47, only through the operation of switching the directional directions of first directional microphone 45 and second directional microphone 47 to any one of the first to third direction patterns.

When switching to any one of the first to third direction patterns is detected, the parameter for each of plural kinds of processing associated with the detected direction pattern by association table 111 is set, on the condition that a switching instruction by the user is accepted. Therefore, unless a switching instruction is accepted after the direction pattern is switched to one of the first to third direction patterns, the parameter for each of plural kinds of processing associated with the detected direction pattern by association table 111 is not set. Accordingly, only the directional directions of first directional microphone 45 and second directional microphone 47 can be switched without changing the recording conditions.

When the user presses OK button 19 while one of the four scene select screens 210, 220, 230, 240 is being displayed on LCD 65, the scene corresponding to the scene select screen displayed at the time when OK button 19 is pressed is selected from the four scene select screens 210, 220, 230, 240.

In response to the selection of a scene by the user, the parameter for each of plural kinds of processing associated with the scene selected by the user from the four scenes by association table 111 is set. Therefore, the user only has to perform the operation of selecting one of the four scenes, so that the parameters to be used to execute plural kinds of processing can be set for the sounds output by first directional microphone 45 and second directional microphone 47, irrespective of the directional directions of first directional microphone 45 and second directional microphone 47.

### Second Embodiment

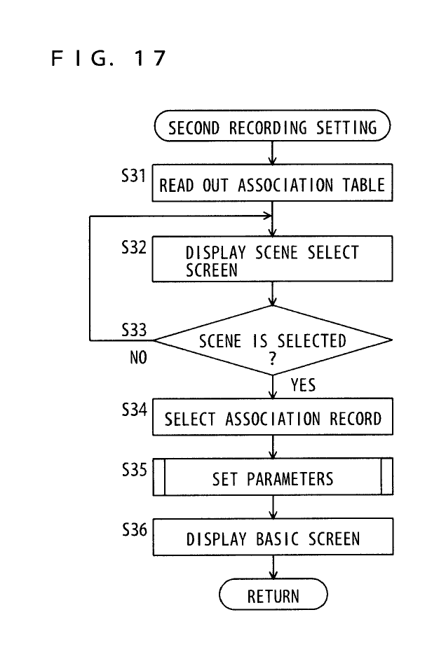

An IC recorder 1000 in a second embodiment of the present invention includes a housing 1012 in the shape of a flat rectangular parallelepiped as shown in FIG. 18 to FIG. 21. On a surface of housing 1012, a display 1014, an operation unit 1018, a record button 1016, and the like are arranged. Housing 1012 can be held and carried.

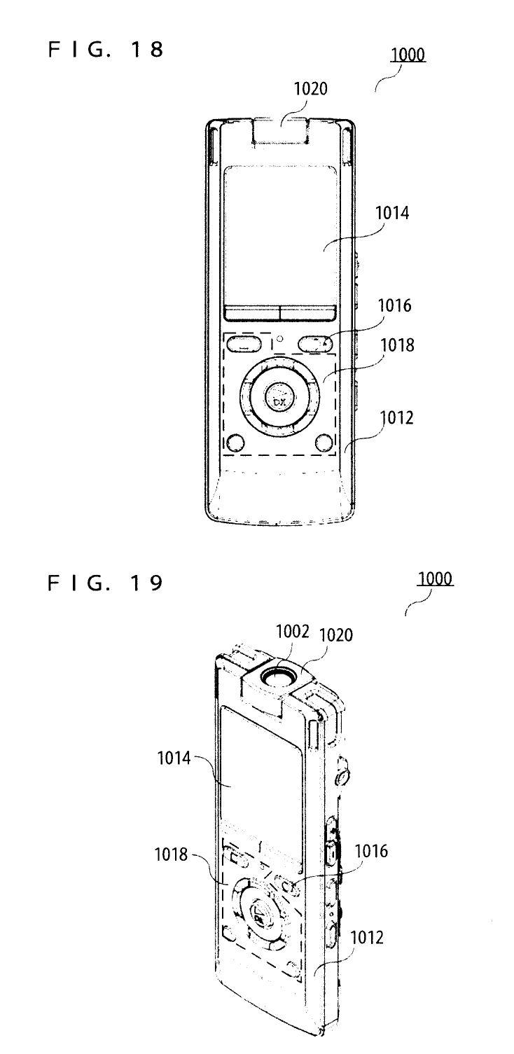

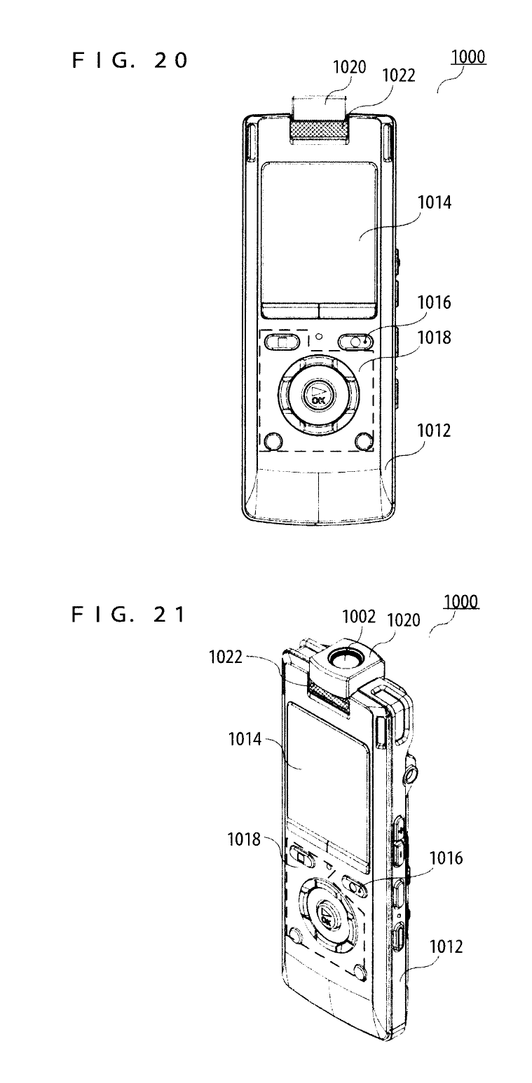

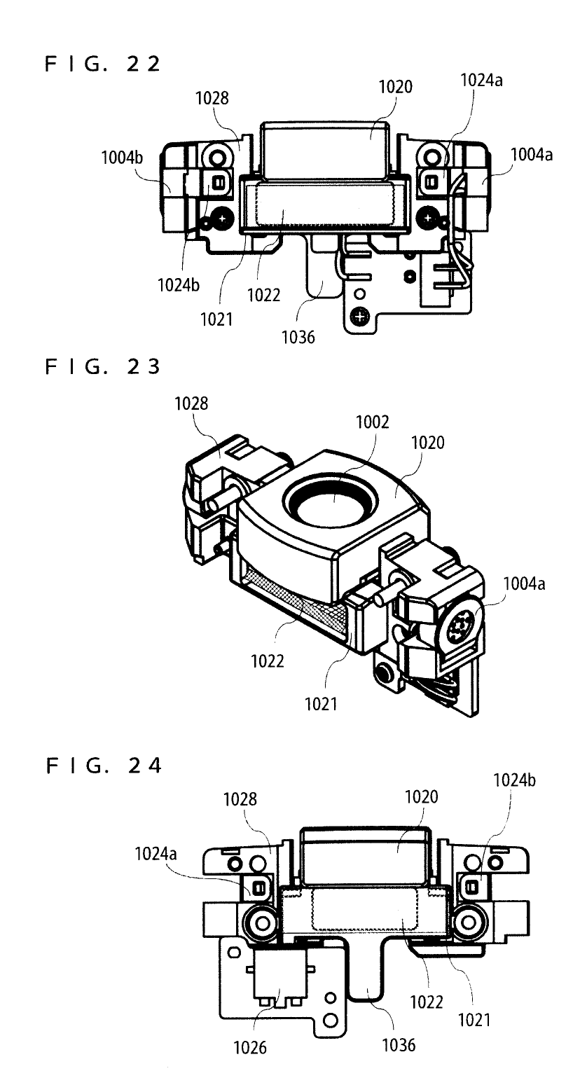

Arranged in an upper portion of housing 1012 are a pair of left and right microphones 1004a and 1004b (see FIGS. 22 and 23) having non-directivity, and a microphone unit 1020 including a microphone 1002 having directivity, and a microphone holder 1021 (see FIGS. 22 and 23) holding microphone 1002. Microphone unit 1020 can be moved, from an accommodation position serving as a first position in which it is accommodated in the center of an arrangement surface of housing 1012 on which microphones 1004a, 1004b are arranged as shown in FIG. 18 and FIG. 19, to a protrusion position serving as a second position in which it is protruded from the arrangement surface of housing 1012 as shown in FIGS. 20 and 21. Microphone unit 1020 is held at each position. Microphone unit 1020 can also be moved from the second position to the first position.

Microphone unit 1020 includes a protection cover 1022 having a mesh portion in the form of a mesh. When microphone unit 1020 is arranged in the second position, protection cover 1022 having the mesh portion is exposed, and a space covered with protection cover 1022 is produced, so that sound can be introduced to the space through the mesh portion, thereby improving the directional characteristics. This space is defined as a cancel space.

Specifically, microphone 1002 includes a not-shown diaphragm. A hole or groove is provided on the back of the diaphragm. Sound produced in the forward direction of microphone 1002, that is, in the protruding direction, reaches the front side of the diaphragm. The same sound enters the hole or groove to reach the back side of the diaphragm with a delay. Because of this time lag, the sound reaching the front side is output without being cancelled. Therefore, when sound is allowed to reach the back side of the diaphragm with an adequate delay in accordance with the directional characteristics of microphone 1002, the directional characteristics is improved, and the sound produced in the protruding direction can be captured more easily. As described above, in the state in which microphone unit 1020 is arranged in the second position, the cancel space is secured for adequately delaying the arrival of sound to the back side of the diaphragm, thereby improving the directional characteristics.

Then, in the state in which microphone unit 1020 is arranged in the second position, protection cover 1022 can prevent intrusion of dusts, etc. into the cancel space, so that the directional characteristics are kept good.

FIG. 22 and FIG. 23 show the upper portion of housing 1012 in detail in the state in which microphone unit 1020 is arranged in the first position. FIG. 22 is a view shown from the front surface of housing 1012 on which display 1014, etc. is disposed. Disposed in the upper portion of housing 1012 are a pair of left and right microphones 1004a, 1004b having no directivity, and a microphone mounting 1028 for holding microphones 1004a, 1004b, microphone unit 1020 arranged between microphone 1004a and microphone 1004b, and microphone holder 1021 included in microphone unit 1020. Microphone mounting 1028 is fixed to housing 1012. More specifically, microphone 1002 is stored in the inside of microphone unit 1020, and microphone unit 1020 is attached to microphone holder 1021.

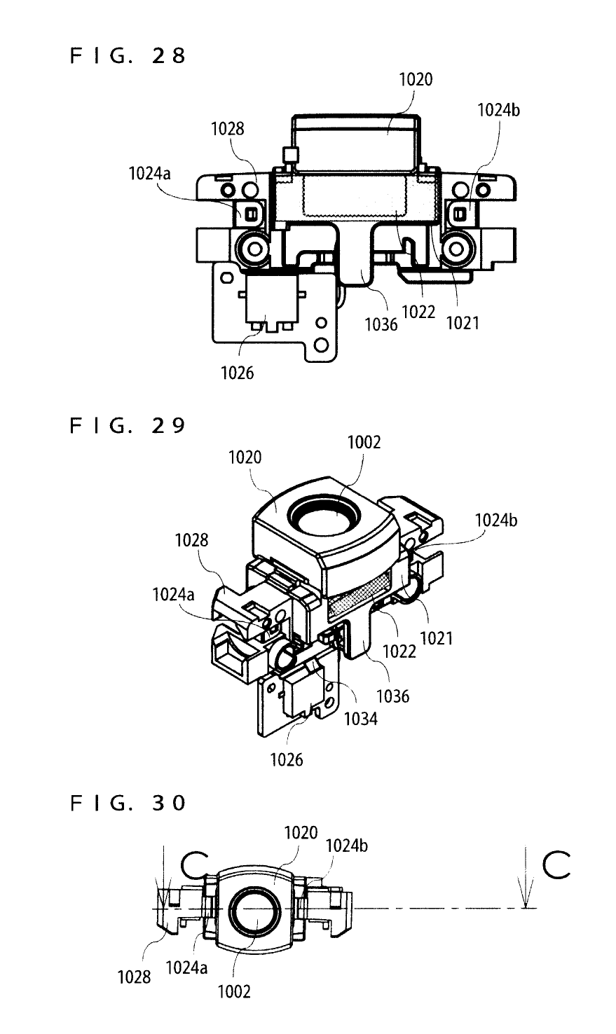

FIG. 24 to FIG. 27 show the state in which microphone unit 1020 is arranged in the first position, excluding microphones 1004a, 1004b disposed in the upper portion of housing 1012 shown in FIG. 22 and FIG. 23. FIG. 28 to FIG. 31 show the state in which microphone unit 1020 is arranged in the second position, excluding microphones 1004a, 1004b.

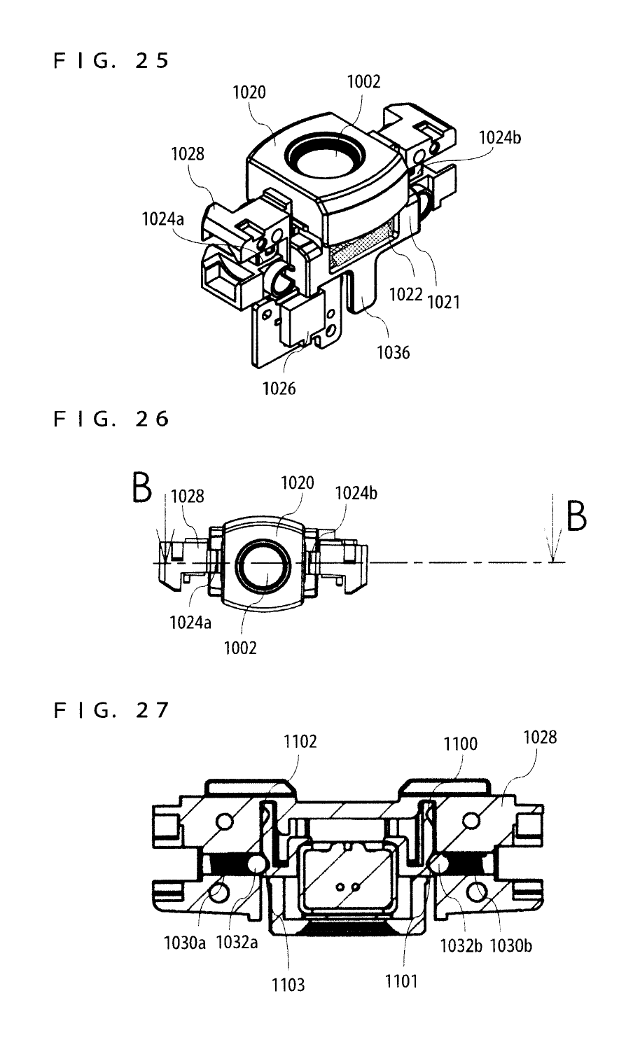

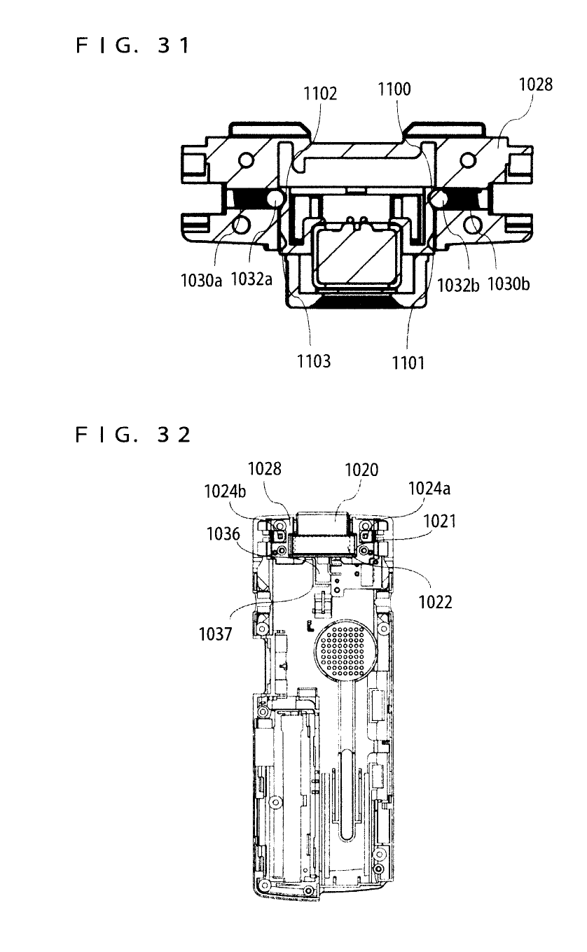

FIG. 24 and FIG. 29 show housing 1012 as viewed from the back. FIG. 25 and FIG. 29 are perspective views of housing 1012 as viewed from the back. FIG. 26 and FIG. 30 are top views of housing 1012 as viewed from the top. FIG. 27 shows a cross-sectional view along line B-B shown in FIG. 26. FIG. 31 shows a cross-sectional view along line C-C shown in FIG. 30.

A switch 1026 is disposed on a lower portion of a surface opposed to microphone holder 1021. A switch knob 1034 is arranged on the upper surface of switch 1026 close to microphone holder 1021. The cancel space covered with protection cover 1022 is provided in microphone holder 1021. A guide rib 1036 is formed in microphone holder 1021. As shown in FIG. 32, housing 1012 has a guide groove 1037 through which guide rib 1036 slides in the vertical direction with respect to housing 1012.

When microphone unit 1020 is arranged in the first position, guide rib 1036 is fitted in guide groove 1037 so that shaking of microphone unit 1020 can be prevented.

As shown in FIG. 24 to FIG. 27, when microphone unit 1020 is arranged in the first position, microphone holder 1021 presses switch knob 1034, so that switch 1026 sends a signal to a CPU 1042 described later through not-shown wiring connected to switch 1026. As shown in FIG. 28 to FIG. 31, when microphone unit 1020 is arranged in the second position, microphone holder 1021 does not press switch knob 1034, so that switch 1026 does not send a signal to CPU 1042.

A pair of microphone holding portions 1024a, 1024b are disposed in microphone mounting 1028. On the outer circumferential surface of microphone holder 1021, as shown in FIG. 27 and FIG. 31, a first engagement receiving portion 1102 and a second engagement receiving portion 1103 that can be engaged with an iron ball 1032a, and a third engagement receiving portion 1100 and a fourth engagement receiving portion 1101 that can be engaged with an iron ball 1032b are provided so as to be depressed at a distance from each other.

Iron balls 1032a, 1032b are biased toward microphone holder 1021 by coil springs 1030a, 1030b. Because of this biasing, iron ball 1032a engages with first engagement receiving portion 1102 and second engagement receiving portion 1103 with pressing force, and iron ball 1032b engages with third engagement receiving portion 1100 and fourth engagement receiving portion 1101 with pressing force.

As shown in FIG. 24 to FIG. 27, when microphone unit 1020 is in the first position, iron ball 1032a engages with second engagement receiving portion 1103 of microphone holder 1021 with pressing force, and iron ball 1032b engages with fourth engagement portion 1101 with pressing force, whereby microphone unit 1020 is held in this position.

When the user applies a force to move microphone unit 1020 from the first position to the second position, irons 1032a, 1032b swing in the direction disengaged from the respective engagement receiving portions, against the biasing by coil springs 1030a, 1030b. Here, microphone unit 1020 can be moved, for example, by such a means as the user picks up microphone unit 1020 with the index finger and thumb or applies a force to push out microphone unit 1020 in the protruding direction with the thumb. Therefore, microphone unit 1020 is desirably sized to be equivalent to or slightly larger than a person's finger.

Then, as shown in FIG. 28 to FIG. 31, when microphone unit 1020 is moved from the first position to the second position, iron ball 1032a engages with first engagement receiving portion 1102 of microphone holder 1021 with pressing force, and iron ball 1032b engages with third engagement receiving portion 1100 with pressing force, whereby microphone unit 1020 is held in the second position.

In IC recorder 1000 as described above, microphone unit 1020 is moved between the first position and the second position and is accurately positioned in the first position and the second position. Therefore, the arrangement desired by the user can be set accurately. Furthermore, when microphone unit 1020 is arranged in the second position, an appropriate cancel space is produced, thereby further improving the directional characteristics of microphone 1002.

Microphone unit 1020 is softly locked by iron balls 1032a, 1032b and coil springs 1030a, 1030b. Thus, even when a minute force is applied by the user to microphone unit 1020 to cause shaking, the shaking is absorbed by the soft locking.

Since the soft locking mechanism is configured such that biasing force is applied by iron balls 1032a, 1032b and coil springs 1030a, 1030b, a constant soft locking force can be applied to microphone unit 1020.

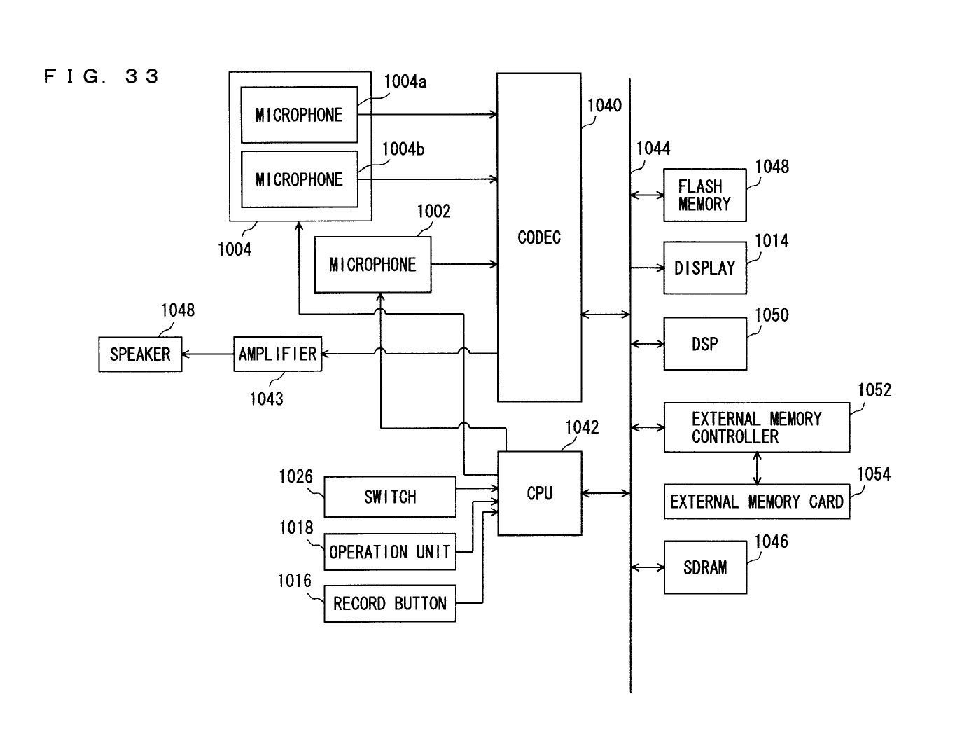

Referring now to the block diagram in FIG. 33, an electrical configuration of IC recorder 1000 will be described.

IC recorder 1000 includes a stereo microphone 1004 including microphones 1004a, 1004b having non-directivity, and microphone 1002 having directivity. Through a recording operation using record button 1016, sounds are collected by microphones 1004a, 1004b and/or microphone 1002, and an output analog sound signal is input to a codec 1040 connected to microphones 1004a, 1004b and/or microphone 1002. Codec 1040 converts the input analog sound signal into a digital signal for prescribed digital processing.

CPU 1042 controlling the entire IC recorder 1000 is connected to a bus 1044 and allows the digital sound data digitally processed by codec 1040 to be temporarily stored into an SDRAM 1046. Codec 1040, CPU 1042, SDRAM 1046, a flash memory 1048, a display 1014, a DSP (Digital Signal Processor) 1050, and an external memory controller 1052 are connected to bus 1044. A program executed by CPU 1042 and parameters for executing the program are stored in flash memory 1048.

Switch 1026, operation unit 1018, and record button 1016 are connected to CPU 1042, so that CPU 1042 grasps the content of an operation in accordance with a signal sent from switch 1026 or an operation on operation unit 1018 and record button 1016, and executes a program corresponding to the content of an operation using a parameter for executing the program.

When MP3 is adopted as a file format for recording, the digital sound data temporarily stored in SDRAM 1046 is output to DSP 1050. DSP 1050 compresses the input digital sound data in the MP3 format and temporarily stores the compressed data as a MP3 audio file into SDRAM 1046. Then, CPU 1042 controls external memory controller 1052 to record the MP3 audio file stored in SDRAM 1046 into an external memory card 1054.

When PCM is adopted as a file format, the digital sound data temporarily stored in SDRAM 1046 is stored as an audio file in the PCM format. CPU 1042 then controls external memory controller 1052 to record the PCM audio file stored in SDRAM 1046 into external memory card 1054. The processing described above, from the processing on analog sound signals output from microphones 1004a, 1004b and/or microphone 1002 to the recording processing, is defined as a recording process, and the mode in which these processing are performed is defined as a recording mode. On the other hand, the mode in which a replay process as described later is performed is defined as a replay mode.

Although each audio file is recorded in external memory card 1054 in the present embodiment, it may be recorded in a not-shown non-volatile internal memory installed in IC recorder 1000.

When a replay start operation is performed on operation unit 1018, CPU 1042 starts and executes a sound reproduction process. Specifically, when an MP3 audio file is to be reproduced, it is temporarily stored from external memory card 1054 into SDRAM 1046 and expanded in DSP 1050. The digital expanded sound signal is stored again into SDRAM 1046 and output to codec 1040. When a PCM audio file is to be reproduced, it is output from external memory card 1054 to codec 1040.

Codec 1040 converts the digital expanded sound signal into an analog expanded sound signal, which is then output to an amplifier 1043 for amplification processing. Then, the amplified signal is output to a speaker 1048. Although each audio file recorded in external memory card 1054 is reproduced in the present embodiment, a not-shown nonvolatile internal memory may be installed in IC recorder 1000 and each audio file recorded in the nonvolatile internal memory may be reproduced.

In IC recorder 1000 in the present embodiment, microphone unit 1020 can be moved, from the accommodation position serving as the first position in which it is accommodated in housing 1012 as shown in FIG. 18 and FIG. 19, to the protrusion position serving as the second position in which it is protruded from housing 1012 as shown in FIG. 20 and FIG. 21, and microphone unit 1020 is held at each position, as described above.

When the recording operation is performed on record button 1016 while microphone unit 1020 is being arranged in the first position, CPU 1042 executes the recording process on the analog sound signal output by microphones 1004a, 1004b collecting sounds. Here, microphone 1002 does not collect sound. Here, the sounds gathering at the places where microphones 1004a, 1004b are arranged are collected and recorded in stereo.

On the other hand, when the recording operation is performed on record button 1016 while microphone unit 1020 is being arranged in the second position, CPU 1042 executes the recording process for the analog sound signal output by microphone 1002 collecting sound. Here, microphones 1004a, 1004b do not collect sounds. Here, sounds in the direction in which microphone 1002 is protruded are mainly collected. This recording is defined as zoom recording.

The user uses either microphone 1002 or a pair of microphones 1004a and 1004b as a microphone performing a sound collecting function, by moving microphone unit 1020 to a desired one of the first and second positions. Therefore, the user can switch the microphones without any complicated procedure. In other words, the switching between the stereo recording and the zoom recording can be done by moving the position of microphone unit 1020.

More specifically, as shown in FIG. 24 to FIG. 27 as described above, in the state in which microphone unit 1020 is arranged in the first position (accommodation position), switch knob 1034 is pressed, so that switch 1026 continuously sends a signal to CPU 1042 described later through not-shown wiring connected to switch 1026. As shown in FIG. 28 to FIG. 31, in the state in which microphone unit 1020 is arranged in the second position (protrusion position), switch knob 1034 is not pressed, so that switch 1026 does not send a signal to CPU 1042.

CPU 1042 determines a value of a flag F stored in flash memory 1048, depending on the presence/absence of a signal from switch 1026, that is, a state of a signal. Specifically, when the presence of a signal is detected, that is, the first position is detected, the value of the flag F is set to “1.” When the absence of a signal is detected, that is, the second position is detected, the value of the flag F is set to “0.”

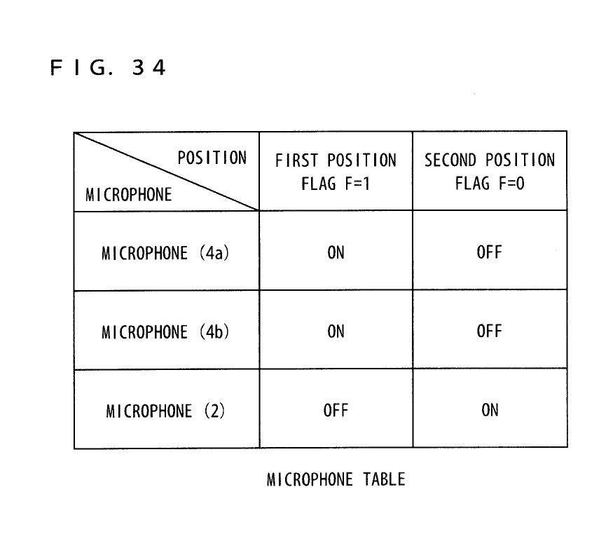

Then, CPU 1042 refers to a microphone table shown in FIG. 34 and sets recording conditions. The microphone table shown in FIG. 34 is a table showing the relation between ON/OFF of microphones 1004a, 1004b and microphone 1002 and the first and second positions based on the values of the flag F.

CPU 1042 sets microphones 1004a, 1004b “ON” to enable a sound collecting operation and sets microphone 1002 “OFF” to disable a sound collecting operation when the first position is determined with reference to the microphone table. CPU 1042 sets microphones 1004a, 1004b “OFF” to disable a sound collecting operation and sets microphone 1002 “ON” to enable a sound collecting operation when the second position is determined.

CPU 1042 further controls microphones 1004a, 1004b and/or microphone 1002, codec 1040, and DSP 1050 with reference to a table concerning recording function setting items, performs processing on the analog sound signals output from microphones 1004a, 1004b and/or microphone 1002 in accordance with the respective recording function setting items, and stores the processed signal into external memory card 1054.

The recording function setting items include “compression ratio” in compressing sounds, “microphone sensitivity” of microphones 1002, 1004a, 1004b, the levels of “filter” for cutting low frequencies corresponding to air conditioner sounds, fan noise from a projector, sound of wind during outdoor recording, and the like, and “recording limiter” for preventing an abrupt excessive input during recording.

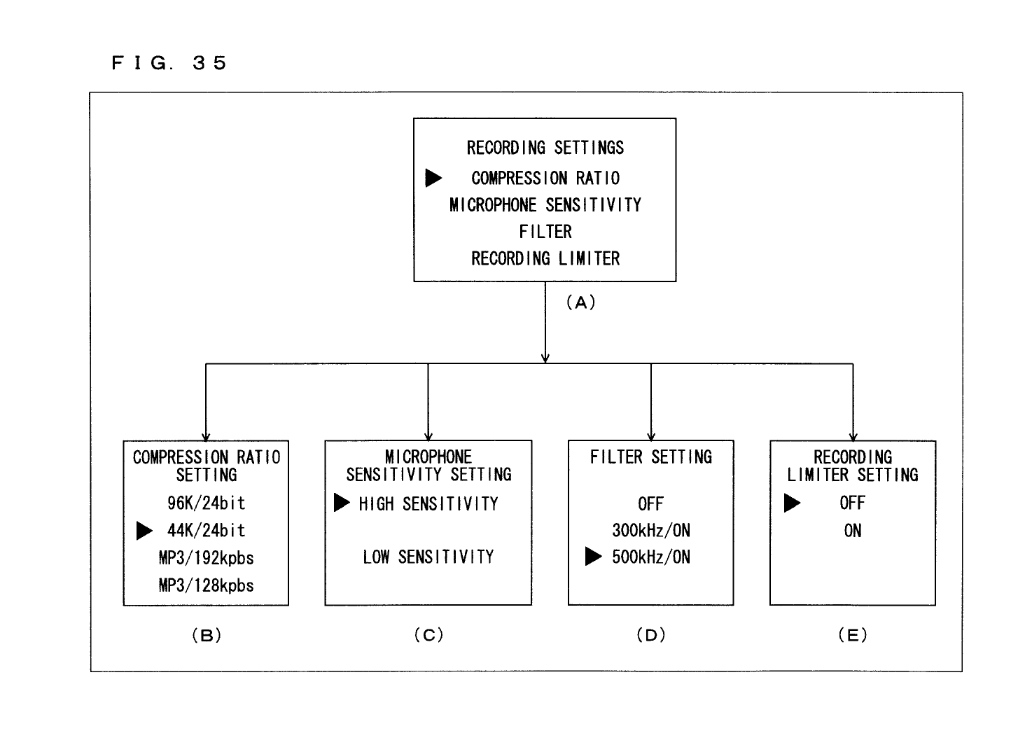

FIG. 35A to FIG. 35E show a transition which takes place when the recording function setting items are changed.

When an operation corresponding to a menu call function is performed on operation unit 1018, CPU 1042 displays a recording settings screen on which one item can be selected from four setting items, “compression ratio,” “microphone sensitivity,” “filter,” and “recording limiter” functions (FIG. 35A).

CPU 1042 displays a setting screen for each item when an operation corresponding to a shift function and a setting function for selecting one of the items is performed on operation unit 1018 while the recording settings screen allowing a selection from the four setting items is being displayed on display 1014 as shown in FIG. 35A. When the item of the “compression ratio” function is selected, a compression ratio setting screen is displayed in which one item can be selected from the four compression ratio setting items “96 k/24 bit” “44 k/24 bit” “MP3/192 kbps” and “MP3/128 kbps” (FIG. 35B).

Here, “96 k/24 bit” indicates that a sound signal is divided 96,000 times per second and the magnitude of sound is represented at 2 to the 24-th power, that is, 16,780,000 levels. “44 k/24 bit” indicates that a sound signal is divided 44,000 times per second and the magnitude of sound is represented at 16,780,000 levels. “MP3/192 kbps” indicates that a sound signal is compressed in the MP3 format at a transfer efficiency of 192 kbps. “MP3/128 kbps” indicates that a sound signal is compressed in the MP3 format at a transfer efficiency of 128 kbps.

When the item of “microphone sensitivity” function is selected while the recording settings screen shown in FIG. 35A is being displayed on display 1014, CPU 1042 displays a microphone sensitivity setting screen in which one of two microphone sensitivity setting items “high sensitivity” and “low sensitivity” can be selected (FIG. 35C).

Here, the microphone sensitivity indicates a level of magnitude at which the analog sound signals output from microphones 1002, 1004a, 1004b are to be output. “High sensitivity” indicates a high level and “low sensitivity” indicates a low level.

Similarly, when the item of “filter function” is selected while the recording settings screen shown in FIG. 35A is being displayed on display 1014, a filter setting screen is displayed in which one item can be selected from three filter setting items, “OFF,” “300 kHz/ON” and “500 kHz/ON” (FIG. 35D).

Here, “300 kHz/ON” indicates that a 300 kHz or lower portion of a sound signal is to be cut. “500 kHz/ON” indicates that a 500 kHz or lower portion of a sound signal is cut.

Similarly, when “recording limiter” is selected while the recording settings screen shown in FIG. 35A is being displayed on display 1014, a recording limiter setting screen is displayed in which one of two recording limiter setting items “OFF” and “ON” can be selected (FIG. 35E).

As for the microphone sensitivity, although the sensitivity is selected by the user (“high sensitivity” or “low sensitivity”), in actuality, the applied sensitivity is set based on the arrangement position of microphone unit 1020 and the sensitivity selected by the user.

Specifically, four sensitivity levels are provided, namely, level 1 to level 4. Level 1 indicates the lowest sensitivity, and the sensitivity level is higher in the order of level 2 and level 3. Level 4 represents the highest sensitivity. Here, the high sensitivity selected by the user is level 3, and the low sensitivity selected by the user is level 1.

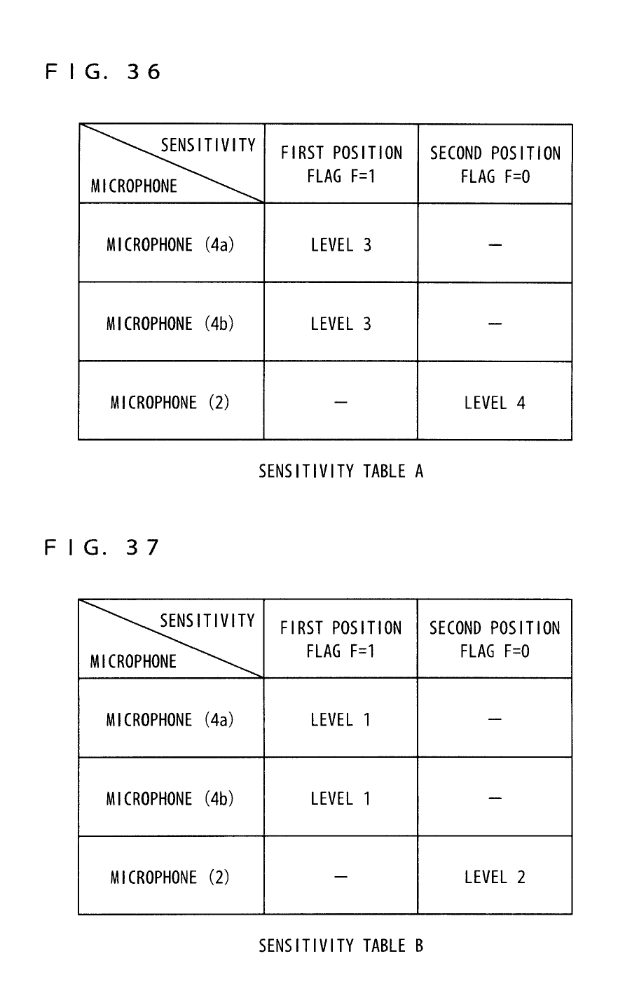

FIG. 36 shows a sensitivity table A showing the relation between the arrangement positions of microphone unit 1020, that is, the values of the flag F and the sensitivity levels of microphones 1002, 1004a, 1004b, in the case where the sensitivity selected by the user is “high sensitivity” (level 3). FIG. 37 shows a sensitivity table B showing the relation between the arrangement positions of microphone unit 1020, that is, the values of the flag F and the sensitivity levels of microphones 1002, 1004a, 1004b, in the case where the sensitivity selected by the user is “low sensitivity” (level 1).

When the user selects “high sensitivity” (level 3) as the desired sensitivity and microphone unit 1020 is arranged in the second position, CPU 1042 refers to the sensitivity table A shown in FIG. 36 and sets the sensitivity level of microphone 1002 to level 4. When microphone unit 1020 is arranged in the first position, the sensitivity level of microphones 1004a, 1004b is set to level 3. Even when the user selects “high sensitivity” that is level 3 as the desired sensitivity, if microphone unit 1020 is arranged in the second position, CPU 1042 sets the sensitivity level of microphone 1002 to level 4, which is higher than level 3 set by the user.

On the other hand, when the user selects “low sensitivity” (level 1) as the desired sensitivity and microphone unit 1020 is arranged in the second position, CPU 1042 refers to the sensitivity table shown in FIG. 37 and sets the sensitivity level of microphone 1002 to level 2. When microphone unit 1020 is arranged in the first position, the sensitivity level of microphones 1004a, 1004b is set to level 1. Even when the user selects “low sensitivity” that is level 1 as the desired sensitivity, if microphone unit 1020 is arranged in the second position, CPU 1042 sets the sensitivity level of microphone 1002 to level 2, which is higher than level 1 set by the user.

CPU 1042 does not adjust the sensitivity for microphones 1004a, 1004b when microphone unit 1020 is arranged in the second position. Similarly, CPU 1042 does not adjust the sensitivity for microphone 1002 when microphone unit 1020 is arranged in the first position. When CPU 1042 does not adjust the sensitivity, the magnitude of output voltage output from microphones 1002, 1004a, 1004b is not adjusted. This is because when microphone unit 1020 is arranged in the first position, microphone 1002 does not collect sound and thus does not require sensitivity adjustment, and when microphone unit 1020 is arranged in the second position, microphones 1004a, 1004b do not collect sound and thus do not require sensitivity adjustment.

Although the user selects the desired sensitivity (level 1 or level 3), CPU 1042 sets the sensitivity level higher than the sensitivity level set by the user, in accordance with the selected sensitivity and the arrangement position of microphone unit 1020. The reason is as follows. When microphone unit 1020 is arranged in the second position (protrusion position), the user is mainly conscious about the sound coming forward, that is, in the protruding direction. Therefore, even though the same “high sensitivity” is selected, it will fit the user's intention if a signal output is greater, that is, the sensitivity level is higher, in the second position than a signal output in the first position (accommodation position).

When microphone unit 1020 is arranged in the first position, microphone 1002 is set OFF, and when microphone unit 1020 is arranged in the second position, microphones 1004a, 1004b are set OFF. Therefore, even if sensitivity is set, those microphones do not output a sound signal. Therefore, the sensitivity level may be set to any level for the microphones set OFF.

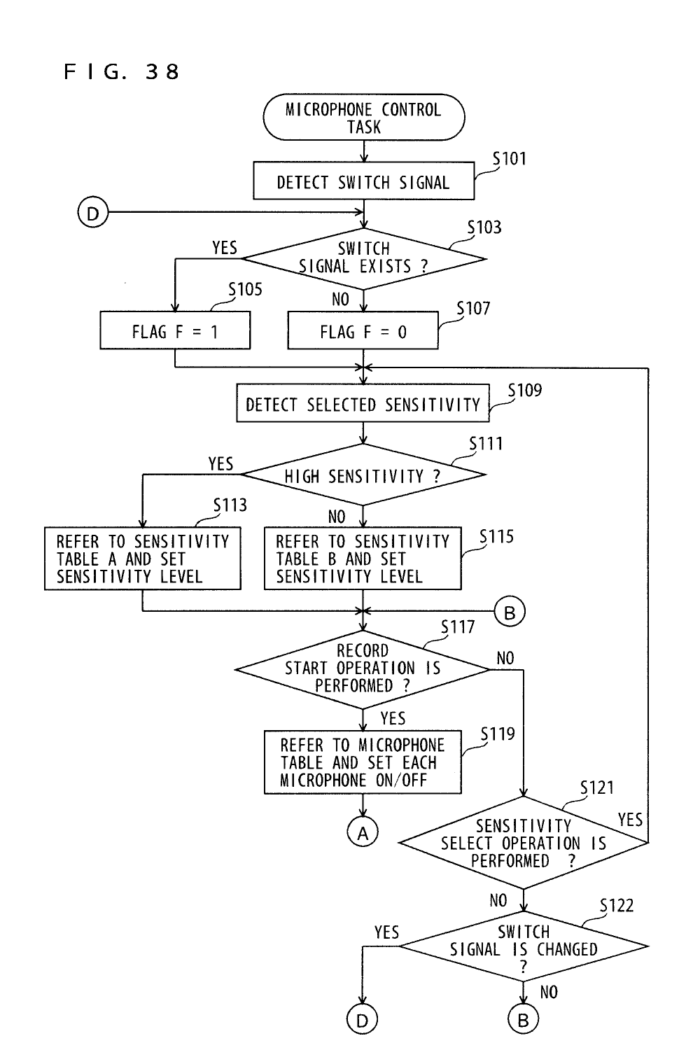

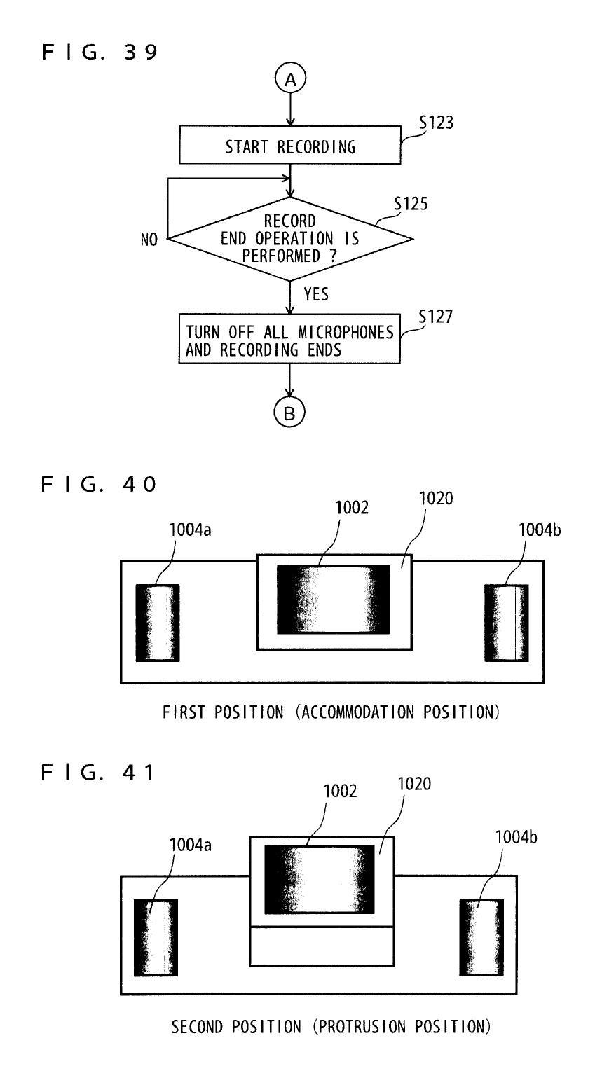

Referring to a flowchart of a microphone control task shown in FIG. 38 and FIG. 39, the processing in the above-noted microphone control will be described. The processing is executed by CPU 1042 when CPU 1042 executes a program stored in flash memory 1048.

When IC recorder 1000 is powered on, CPU 1042 detects a signal from switch 1026 in step S101. Then, the process proceeds to step S103, and it is determined whether a signal from switch 1026 is input. If the determination is YES in step S103, the process proceeds to step S105, and the value of the flag F is set to 1. The process then proceeds to step S109. If the determination is NO in step S103, the process proceeds to step S107, and the value of the flag F is set to 0. The process then proceeds to step S109.

In step S109, the sensitivity selected by the user is detected. Specifically, it is detected whether “high sensitivity” or “low sensitivity” is selected. Then, the process proceeds to step S111, and it is determined whether the selected sensitivity is “high sensitivity.” If the determination is YES in step S111, the process proceeds to step S113, and the sensitivities of microphones 1002, 1004a, 1004b are set with reference to the sensitivity table shown in FIG. 36. The process then proceeds to step S117. If the determination is NO in step S111, the process proceeds to step S115, and the sensitivities of microphones 1002, 1004a, 1004b are set with reference to the sensitivity table B shown in FIG. 37. The process then proceeds to step S117.

In step S117, it is determined whether the recording start operation is performed by operating record button 1016. If the determination is NO in step S117, the process proceeds to step S121, and it is determined whether the operation of selecting sensitivity is performed by the user. If the determination is YES in step S121, the process returns to step S109. If the determination is NO, the process proceeds to step S122. In step S122, it is determined whether a signal from switch 1026 is changed. If the determination is YES in step S122, the process returns to step S103. If the determination is NO, the process returns to step S117.

Then, if the determination is YES in step S117, the process proceeds to step S119, and ON/OFF of each microphone is set with reference to the microphone table shown in FIG. 34. The process then proceeds to step S123, and the execution of the recording process is started based on the analog sound signal output from the microphone. The process then proceeds to step S125. In step S125, it is determined whether the recording end operation is performed by operating operation unit 1018. The determination as to whether the recording end operation is performed is repeated until YES determination is made.

If the determination is YES in step S125, the process proceeds to step S127, and all microphones 1002, 1004a, 1004b are set OFF. The recording process then ends, and the process returns to step S117.

As described above, in IC recorder 1000 in the present embodiment, the microphone for collecting sound is set in accordance with the arrangement position of the movable microphone unit 1020, so that the user can record sound in the desired recording manner only by moving microphone unit 1020. Since the user can set appropriate microphone sensitivity only by moving microphone unit 1020, sound can be recorded under more appropriate recording conditions.

Microphone unit 1020 is moved between the first position and the second position and is positioned accurately at the first position and the second position, so that the arrangement desired by the user can be set precisely. When microphone unit 1020 is arranged in the second position, an appropriate cancel space is produced, thereby further improving the directional characteristics of microphone 1002. When microphone unit 1020 is arranged in the first position, the appropriate cancel space for microphone 1002 disappears. However, this poses no problem in recording because sound collection is not performed by microphone 1002. In this way, the user can record high-quality sound by moving microphone unit 1020 without being aware of the directional characteristics of the microphones.

In the second embodiment, even when microphone unit 1020 is moved during the recording process, the microphone that is collecting sound and the level of sensitivity are not changed until a stop operation is performed by operation unit 1018.

<Modification of Second Embodiment>

A modification of the second embodiment of the present invention will now be described. An IC recorder in a modification of the second embodiment has a basic structure similar to IC recorder 1000 shown in the second embodiment except that it allows direct setting in which parameters can be automatically set in recording function setting items (“compression ratio,” “microphone sensitivity,” “ALC,” “filter,” and “recording limiter”), depending on the arrangement of microphone unit 1020. Therefore, differences from IC recorder 1000 in the foregoing second embodiment will be mainly described below.

FIG. 40 and FIG. 41 are schematic diagrams showing the state in which microphone unit 1020 is arranged in the first position (accommodation position) and the state in which microphone unit 1020 is arranged in the second position (protrusion position), respectively, in the upper portion of housing 1012.

When IC recorder 1000 changes from power OFF state to power ON state, CPU 1042 sets the value of the flag F stored in flash memory 1048 in accordance with a state of a signal from switch 1026 and allows display 1014 to display a prescribed screen in accordance with the set value. Specifically, if the value of the flag F is “1,” as shown in FIG. 43, a screen showing “stereo mode” of collecting sound by microphones 1004a, 1004b is displayed for 2 seconds. If the value of the flag is “0,” as shown in FIG. 44, a screen showing “zoom mode” of collecting sound by microphone 1002 is displayed for two seconds.

In addition to power-on of IC recorder 1000, when the arrangement position of microphone unit 1020 is changed, specifically, when the state in which microphone unit 1020 is arranged in the first position (accommodation position) is changed to the arrangement of the second position (protrusion position), CPU 1042 controls such that the screen showing “zoom mode” shown in FIG. 44 is displayed for two seconds. When the state in which microphone unit 1020 is arranged in the second position is changed to the arrangement of the first position, CPU 1042 controls such that the screen showing “stereo mode” shown in FIG. 43 is displayed for two seconds. In other words, a state change of a signal sent continuously or at regular intervals from switch 1026 triggers CPU 1042 to set the value of the flag F in accordance with the changed state of the signal, and CPU 1042 allows display 1014 to display a prescribed screen in accordance with the set value.

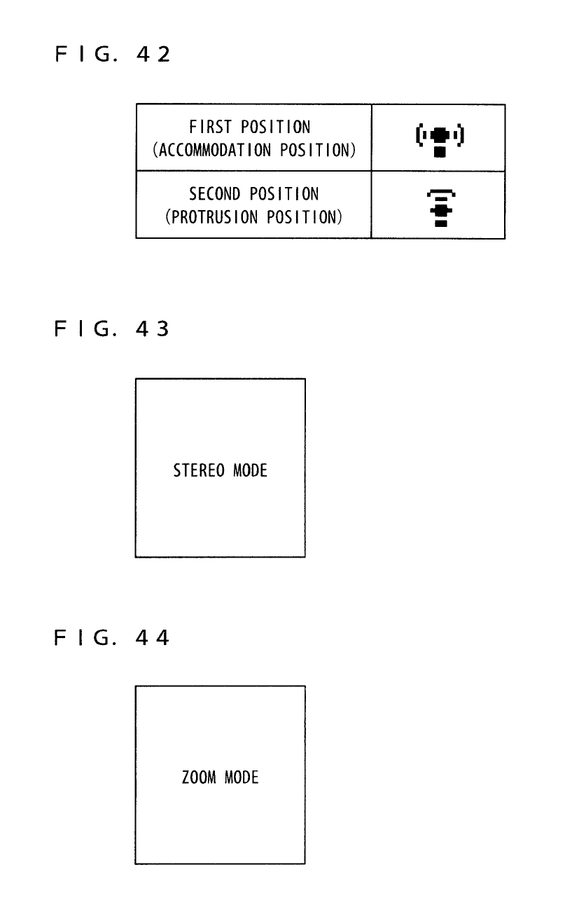

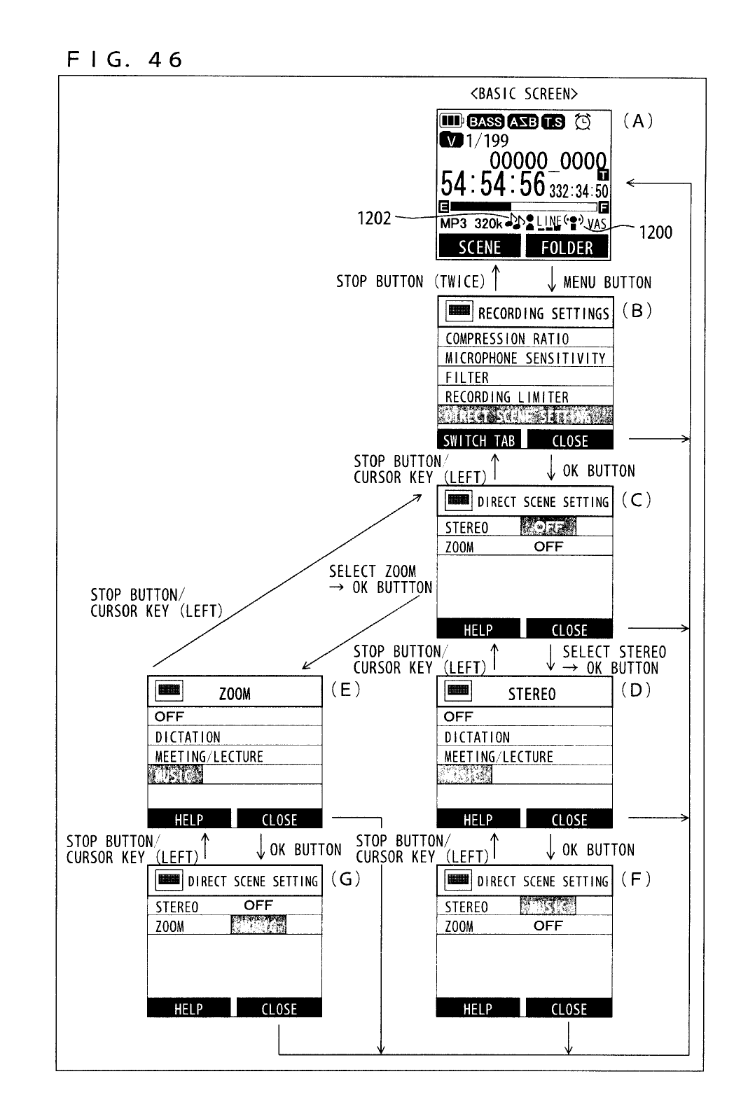

As shown in FIG. 43 and FIG. 44, after the message indicating “stereo mode” or “zoom mode” is displayed on the screen for two seconds, a basic screen shown in FIG. 46A, that is, a recording standby screen is displayed. Various information is displayed on the basic screen. Specifically, a mark 1202 shows a registered recording scene, and a mark 1200 shows the current mode in which the microphone is collecting sound. Mark 1200 displayed on the basic screen is the mark corresponding to the first position shown in FIG. 42 when microphone unit 1020 is arranged in the first position. Mark 1200 is the mark corresponding to the second position shown in FIG. 42 when microphone unit 1020 is arranged in the second position. In the basic screen shown in FIG. 46A, the mark corresponding to the first position is displayed as mark 1200.

With increasing variety of recording scenes and expanded functionality in recent IC recorders, parameters of a plurality of recording function setting items (“compression ratio,” “microphone sensitivity,” “ALC,” “filter,” and “recording limiter”) have to be set for each situation (scene) in which the user records sounds.

Then, IC recorder 1000 in the modification of the second embodiment holds parameters suitable for each of a plurality of predetermined recording scenes. More specifically, recommended parameters for recording function setting items are set correspondingly for each of a plurality of recording scenes.

Then, when the user selects the desired recording scene, parameters suitable for the selected scene are set in the recording function setting items. Then, when record button 1016 is pressed, the recording process is executed based on the parameters set in the recording function setting items.

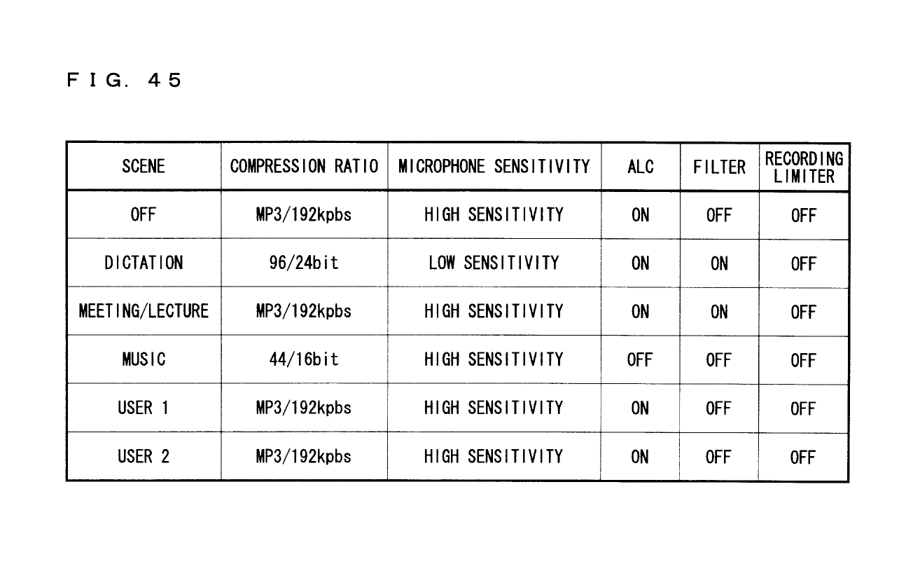

The relation between the recording function setting items and the recording scenes will be described with reference to FIG. 45. A recording scene table shown in FIG. 45 is stored in flash memory 1048. The recording scene table associates each of a plurality of recording scenes with the recommended parameters for “compression ratio,” “microphone sensitivity,” “ALC,” “filter,” and “recording limiter” as recording function setting items.

The functions of “compression ratio,” “microphone sensitivity,” “filter,” and “recording limiter” are similar to the functions of IC recorder 1000 in the second embodiment. “ALC” is a function of automatically adjusting the volume in order to record sound automatically at an appropriate volume. Recording scenes “user 1” and “user 2” are recording scenes in which parameters set by the user are stored. Default values are stored as parameters for the recording function setting items, in “user 1” and “user 2” shown in FIG. 45.

When the menu is read out through the user's operation, and a desired scene is selected as a recording scene from among “OFF,” “dictation,” “meeting/lecture,” “music,” “user 1,” and “user 2”, CPU 1042 refers to the recording scene table shown in FIG. 45, so that the parameters corresponding to the selected scene are automatically set in the respective recording function setting items.

In the absence of the scene selection operation by reading out the menu, if the user designates a recording scene beforehand corresponding to the arrangement of microphone unit 1020, then CPU 1042 refers to the recording scene table shown in FIG. 45 and automatically sets the parameters corresponding to the designated recording scene in the recording function setting items, in accordance with the arrangement of microphone unit 1020. This function of CPU 1042 automatically setting parameters in the recording function setting items in accordance with the arrangement of microphone unit 1020 is referred to as direct scene setting.

The procedure of designating a recording scene for the arrangement of microphone unit 1020 will be described with reference to FIG. 46A to FIG. 46G.

When the menu button included in operation unit 1018 is pressed while the basic screen is being displayed on display 1014 as shown in FIG. 46A, CPU 1042 displays a recording settings screen shown in FIG. 46B. Displayed in the recording settings screen are items with which the functions “compression ratio,” “microphone sensitivity,” “filter,” “recording limiter,” and “direct scene setting” can be selected. For example, when the item of the function “compression ratio” is selected, a compression ratio setting screen appears in which a parameter for compression ratio can be selected. The selected parameter here is set in the recording function setting item, and upon the next recording start operation, CPU 1042 executes the recording process based on the set parameter.

When the stop button included in operation unit 1018 is pressed in the recording settings screen shown in FIG. 46B, the screen returns to FIG. 46A. When the item “direct scene setting” is selected by the cursor key included in operation unit 1018 and the OK button is pressed in this screen, CPU 1042 display a screen showing the details of the direct scene setting as shown in FIG. 46C.

In the direct scene setting details screen, the user can operate operation unit 1018 to set the recording scene that is enabled in “stereo mode,” that is, when microphone unit 1020 is arranged in the first position (accommodation position). Similarly, the user can operate operation unit 1018 to set the recording scene that is enabled in “zoom mode,” that is, when microphone unit 1020 is arranged in the second position (protrusion position).

In FIG. 46C, the recording mode is set OFF both in “stereo mode” and “zoom mode. This means that the direct scene setting is OFF. Therefore, the automatic parameter setting in the recording function setting items with reference to the recording scene table is not done, upon power-up or in response to an arrangement change of microphone unit 1020. When the character string “OFF” shown in the same line as “stereo” in the screen shown in FIG. 46C is selected through the operation of operation unit 1018, CPU 1042 displays a stereo details screen shown in FIG. 46D.

In the stereo details screen, the user can operate operation unit 1018 to select a recording scene from the recording scenes “OFF,” “dictation,” “meeting/lecture,” and “music.” If the user desires the “music” scene as a recording scene when arranging microphone unit 1020 in the first position, the user selects/determines “music” through operation unit 1018 in the stereo details screen shown in FIG. 46D. Then, CPU 1042 displays a direct scene setting details screen shown in FIG. 46F. In FIG. 46F, “music” is displayed in place of “OFF” displayed in FIG. 46C.

Through the operation in this manner, the user enables the “music scene” as a recording scene in “stereo mode,” in other words, when microphone unit 1020 is arranged in the first position (accommodation position). When the “music” scene is enabled as a recording scene, the parameters corresponding to the “music” scene, which are stored in the recording scene table, are automatically set in the recording function setting items. Then, when record button 1016 is pressed, the recording process is executed using the set parameters.

When the character string “OFF” shown in the same line as “zoom” is selected in the direct scene setting details screen, CPU 1042 displays a zoom details screen shown in FIG. 46E. When “music” is selected and determined through a similar procedure as in the stereo details screen, CPU 1042 displays a direct scene setting details screen shown in FIG. 46G. In the direct scene setting details screen, the “music” scene is enabled as a recording scene in “zoom mode,” in other words, when microphone unit 1020 is arranged in the second position (protrusion position). When the “music” scene is enabled as a recording scene, the parameters corresponding to the “music” scene, which are stored in the recording scene table, are automatically set in the recording function setting items.

When the stop button and/or the cursor key included in operation unit 1018 is operated in the screens shown in FIG. 46B to FIG. 46G, the screen returns to the immediately preceding one (if the cursor key is operated in the screen shown in FIG. 46B, the screen returns to the screen in FIG. 46A).

As described above, if the user designates in advance a desired recording scene corresponding to the arrangement of microphone unit 1020, the recommended parameters corresponding to the designated recording scene are automatically set in the recording function setting items in accordance with the arrangement of microphone unit 1020, thereby facilitating the setting operation for recording. Furthermore, at power-up or when the arrangement of microphone unit 1020 is changed, a screen showing which microphone will collect sound is displayed for a certain time, so that the user can easily recognize the current recording mode.

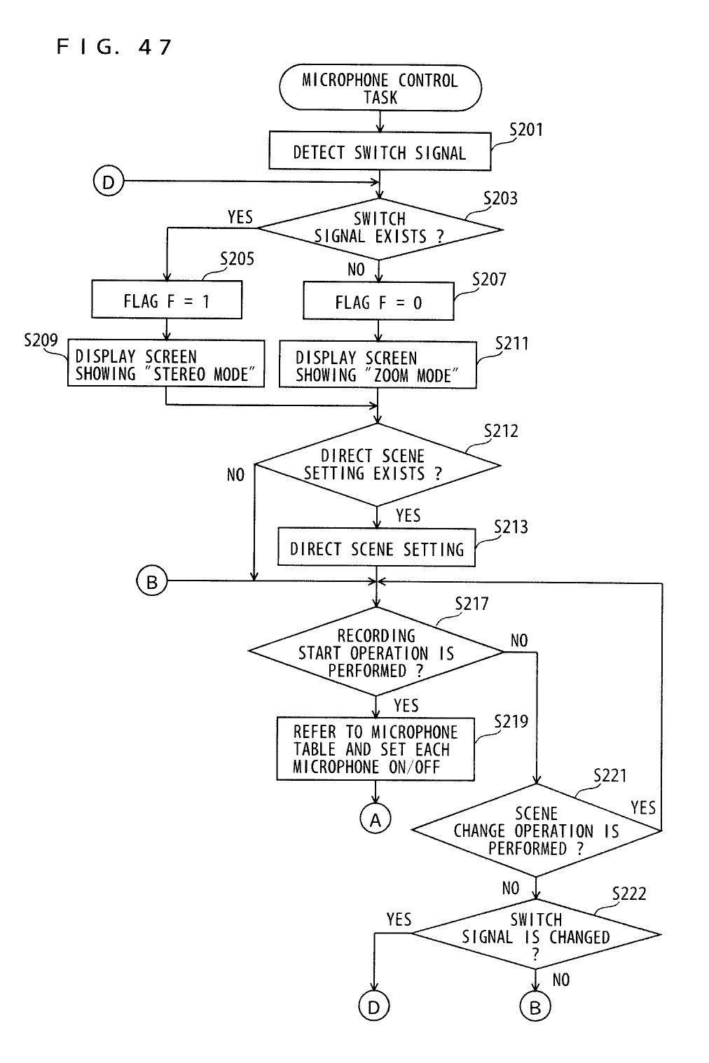

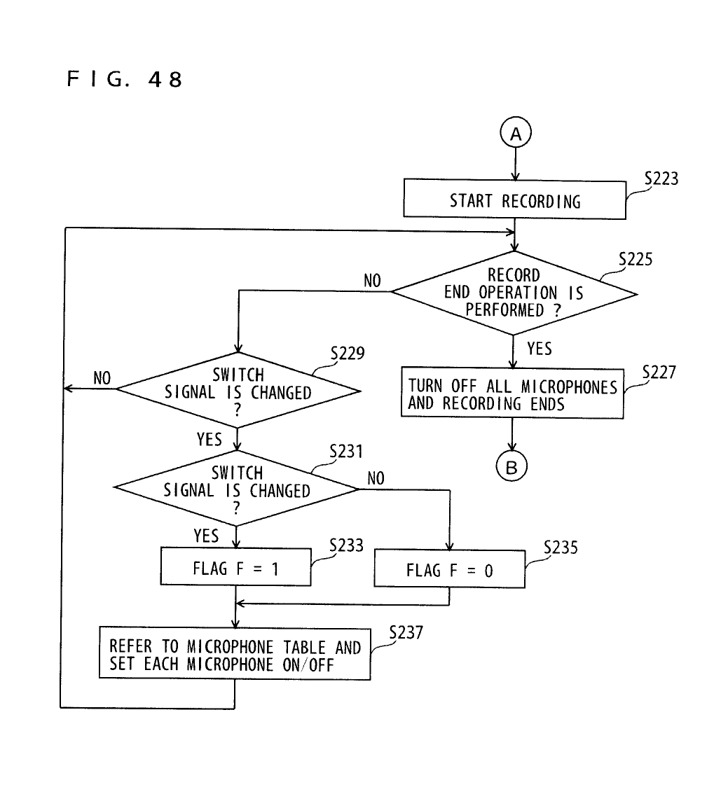

The processing in microphone control in the modification of the second embodiment as described above will be described with reference to a flowchart of a microphone control task in the modification of the second embodiment as shown in FIG. 47 and FIG. 48. The processing shown in FIG. 47 and FIG. 48 is executed by CPU 1042 when CPU 1042 executes a program stored in flash memory 1048.

When IC recorder 1000 is powered on, CPU 1042 detects a signal from switch 1026 in step S201. Then, the process proceeds to step S203, and it is determined whether a signal is input from switch 1026. If the determination is YES in step S203, the process proceeds to step S205, and the value of the flag F is set to 1. The process then proceeds to step S209. In step S209, the “stereo mode” screen is displayed on display 1014 to indicate that sound will be collected by microphones 1004a, 1004b when recording button 1016 is pressed from now on. The process then proceeds to step S213.

If the determination is NO in step S203, CPU 1042 proceeds to step S207 and sets the value of the flag F to 0. In the next step S211, the “zoom mode” screen is displayed to indicate that sound will be collected by microphone 1002.

In the next step S212, it is determined whether the direct scene setting is made in the current arrangement of microphone unit 1020. Specifically, it is determined whether there exists a scene allocated to the first position if microphone unit 1020 is arranged in the first position, or whether there exists a scene allocated to the second position if microphone unit 1020 is arranged in the second position. If the determination is YES in step S212, the process proceeds to step S213, and the above-noted direct scene setting is executed, and the process proceeds to step S217. If the determination is NO in step S212, the process proceeds to step S217.

In step S217, it is determined whether a recording start operation is performed. The recording start operation is detected when record button 1016 is operated. If the determination is NO in step S217, the process proceeds to step S221, and it is determined whether a change operation to another scene is performed. In this change operation, the user operates operation unit 1018 with reference to a screen displayed on display 1014 thereby changing a scene.

If the determination is YES in step S221, the process returns to step S217. If the determination is NO in step S221, the process proceeds to step S222. In step S222, it is determined whether a signal from switch 1026 is changed. If the determination is YES in step S222, the process returns to step S203. If the determination is NO in step S222, the process returns to step S217.

If the determination is YES in step S217, the process proceeds to step S219, and ON/OFF is set for each microphone with reference to the microphone table shown in FIG. 34. Then, the process proceeds to step S223, and the execution of the recording process is started based on the analog sound signal output from the microphone. The process then proceeds to step S225. In step S225, it is determined whether a recording end operation is performed by operating operation unit 1018. The determination as to whether a recording end operation is performed is repeated until YES determination is made.

If the determination is YES in step S225, the process proceeds to step S227, and all the microphones 1002, 1004a, 1004b are set OFF. The recording process then ends, and the process returns to step S217.

If the determination is NO in step S225, the process proceeds to step S229, and it is determined whether a signal from switch 1026 is changed. If the determination is NO in step S229, the process returns to step S225. If the determination is YES in step S229, the process proceeds to step S231. In step S231, it is determined whether a signal is input from switch 1026. If the determination is YES in step S231, the process proceeds to step S233, and the value of the flag F is set to 1. The process then proceeds to step S237. If the determination is NO in step S231, the process proceeds to step S235, and the value of the flag F is set to 0. The process then proceeds to step S237. In step S237, ON/OFF is set for each microphone with reference to the microphone table shown in FIG. 34. The process then returns to step S225.

In the modification of the second embodiment, when the arrangement of microphone unit 1020 is changed during a process (for example, a relay process) other than the recording process, the value of the flag F is set in accordance with a signal from switch 1026, the microphone table shown in FIG. 34 is set, and ON/OFF of each microphone is set.

In the second embodiment and the modification thereof, microphone unit 1020 is moved by such a means as the user picks up microphone unit 1020 with the index finger and thumb or applies a force to push out microphone unit 1020 in the protruding direction. However, the present invention is not limited thereto, and microphone unit 1020 may be moved automatically by pressing a not-shown button.

In the second embodiment and the modification thereof, whether microphone unit 1020 is in the first position or the second position is detected by such a means as switch 1026 sends a signal to CPU 1042. However, the state of switch 1026 may be detected by CPU 1042 monitoring switch 1026. For example, switch 1026 may be configured to include a resistance so that current flowing through the resistance changes when switch knob 1034 is pressed. Then, whether microphone unit 1020 is in the first position or the second position may be detected by measuring voltages across the resistance in the pressed state and in the not-pressed state.

It is noted that IC recorder 1, 1000 are illustrated as an example of the recording apparatus in the embodiments, the present invention can be understood as a recording condition setting method to cause IC recorder 1, 1000 to execute the processes shown in FIG. 14-FIG. 17, FIG. 38, FIG. 39, FIG. 47, and FIG. 48 and as a recording condition setting program to cause CPU 11, 1042 to execute the recording condition setting method, as a matter of course.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A recording apparatus comprising:
a plurality of microphones having directivity to output collected sound;
a switch portion to switch a direction of directivity of each of said plurality of microphones to one of a plurality of predetermined direction patterns;
a detection portion to detect a direction pattern switched by said switch portion among said plurality of direction patterns;
a recording portion to execute plural kinds of processing on sound collected by said plurality of microphones and to record the processed sound;
a setting portion to set parameters to be used by said recording portion to execute said plural kinds of processing; and
a storage portion to store the parameters to be used by said recording portion to execute said plural kinds of processing, separately for each of said plural kinds of processing, in association with each of said plurality of direction patterns,
wherein when a direction pattern switched by said switch portion is detected by said detection portion, said setting portion sets the parameters to be used to execute plural kinds of processing that are associated with the detected direction pattern.

2. The recording apparatus according to claim 1, wherein said setting portion includes a switch instruction accepting portion to accept a switch instruction by a user when a direction pattern switched by said switch portion is detected by said detection portion, and the parameters to be used to execute plural kinds of processing that are associated with said detected direction pattern are set on the condition that said switch instruction is accepted.

3. The recording apparatus according to claim 1, wherein
said storage portion stores the parameters to be used by said recording portion to execute said plural kinds of processing, separately for each of said plural kinds of processing, in association with each of a plurality of scenes equal to or more than the number of said plurality of direction patterns, each of said plurality of direction patterns being related with any one of said plurality of scenes,
the recording apparatus further comprises a selection accepting portion to accept a selection by a user from said at least one scenes, and
in response to said selection accepting portion accepting the selection by the user, said setting portion sets the parameters to be used to execute plural kinds of processing that are associated with a scene selected by said user from among said plurality of scenes.

4. The recording apparatus according to claim 1, further comprising:
a change instruction accepting portion to accept a change instruction by a user; and
a change portion to change a parameter associated, for each of said plural kinds of processing, with each of said plurality of scenes, in accordance with said accepted change instruction.

5. The recording apparatus according to claim 1, wherein said plural kinds of processing include at least one selected from: processing of adjusting microphone sensitivity; processing of adjusting an input level at an appropriate level; processing of compensating for sound at low frequencies; processing of cutting sound at low frequencies; processing of encoding a sound signal; processing of setting a volume level to a value not greater than a prescribed value; processing of starting recording at a predetermined time; and processing of cutting a silent portion.

6. A recording apparatus having a plurality of microphones to collect sound comprising:
a first microphone and a second microphone having no directivity;
a third microphone having directivity;
a moving portion to allow said third microphone to move, from an accommodation position in which said third microphone is accommodated in an arrangement surface of a housing on which said first microphone and said second microphone are arranged, to a protrusion position in which said third microphone is protruded with respect to said arrangement surface; and
a setting portion to set any one of a plurality of recording conditions as a condition for recording, in accordance with a position of said third microphone.

7. The recording apparatus according to claim 6, wherein
said plurality of recording conditions include a first recording condition under which recording is based on sound signals output from said first microphone and said second microphone and a second recording condition under which recording is based on a sound signal output from said third microphone, and
said setting portion sets said first recording condition as a condition for recording when said third microphone is in said accommodation position, and said setting portion sets said second recording condition as a condition for recording when said third microphone is in said protrusion position.

8. The recording apparatus according to claim 6, further comprising:
a sensitivity selection portion to select sensitivity for said plurality of microphones; and
a sensitivity setting portion to set sensitivity higher than said selected sensitivity for said third microphone when said third microphone is in said protrusion position.

9. A recording condition setting method executed in a recording apparatus including a plurality of microphones having directivity to output collected sound, a switch portion to switch a direction of directivity of each of said plurality of microphones to one of a plurality of predetermined direction patterns, a recording portion to execute plural kinds of processing on sound collected by said plurality of microphones and to record the processed sound and a storage portion to store parameters to be used by said recording portion to execute said plural kinds of process, separately for each of said plural kinds of processing, in association with each of said plurality of direction patterns, comprising the steps of:
detecting a direction pattern switched by said switch portion among said plurality of direction patterns; and
setting the parameters to be used to execute plural kinds of processing that are associated with the detected direction pattern, when a direction pattern switched by said switch portion is detected in said step of detecting.

10. The recording condition setting method according to claim 9, further comprising the steps of;
when a direction pattern switched by said switch portion is detected in said step of detecting, accepting a switch instruction by a user; and
setting the parameters to be used to execute plural kinds of processing that are associated with said detected direction pattern, on the condition that said switch instruction is accepted.

11. The recording condition setting method according to claim 9, wherein
said storage portion stores the parameters to be used by said recording portion to execute said plural kinds of processing, separately for each of said plural kinds of processing, in association with each of a plurality of scenes equal to or greater than the number of said plurality of direction patterns, each of said plurality of direction patterns being related with any one of said plurality of scenes,
the method further comprising the steps of accepting a selection by a user from said at least one scenes, and
setting the parameters to be used to execute plural kinds of processing that are associated with a scene selected by said user from among said plurality of scenes.

12. The recording condition setting method according to claim 9, further comprising the steps of;
accepting a change instruction by a user; and
changing a parameter associated, for each of said plural kinds of processing, with each of said plurality of scenes, in accordance with said accepted change instruction.

13. The recording condition setting method according to claim 9, wherein said plural kinds of processing include at least one selected from: processing of adjusting microphone sensitivity; processing of adjusting an input level at an appropriate level; processing of compensating for sound in low frequencies; processing of cutting sound in low frequencies; processing of encoding a sound signal; processing of setting a volume level to a value not greater than a prescribed value; processing of starting recording at a predetermined time; and processing of cutting a silent portion.

14. A non-transitory computer-readable recording medium encoded with a recording condition setting program executed in a computer controlling a recording apparatus including a plurality of microphones having directivity to output collected sound, a switch portion to switch a direction of directivity of each of said plurality of microphones to one of a plurality of predetermined direction patterns, a recording portion to execute plural kinds of processing on sound collected by said plurality of microphones and to record the processed sound and a storage portion to store parameters to be used by said recording portion to execute said plural kinds of process, separately for each of said plural kinds of processing, in association with each of said plurality of direction patterns, said recording condition setting program causing said computer to execute processing comprising the steps of:
detecting a direction pattern switched by said switch portion among said plurality of direction patterns; and
setting the parameters to be used to execute plural kinds of processing that are associated with the detected direction pattern, when a direction pattern switched by said switch portion is detected in said step of detecting.

15. The non-transitory computer-readable recording medium encoded with a recording condition setting program according to claim 14, further comprising the steps of:
when a direction pattern switched by said switch portion is detected in said step of detecting, accepting a switch instruction by a user; and
setting the parameters to be used to execute plural kinds of processing that are associated with said detected direction pattern, on the condition that said switch instruction is accepted.

16. The non-transitory computer-readable recording medium encoded with a recording condition setting program according to claim 14, wherein
said storage portion stores the parameters to be used by said recording portion to execute said plural kinds of processing, separately for each of said plural kinds of processing, in association with each of a plurality of scenes equal to or greater than the number of said plurality of direction patterns, each of said plurality of direction patterns being related with any one of said plurality of scenes,
said recording condition setting program further causes said computer to execute the step of accepting a selection by a user from said at least one scenes, and
setting the parameters to be used to execute plural kinds of processing that are associated with a scene selected by said user from among said plurality of scenes.

17. The non-transitory computer-readable recording medium encoded with a recording condition setting program according to claim 14, wherein said recording condition setting program further causes said computer to execute the steps of:
accepting a change instruction by a user; and
changing a parameter associated, for each of said plural kinds of processing, with each of said plurality of scenes, in accordance with said accepted change instruction.

18. The non-transitory computer-readable recording medium encoded with a recording condition setting program according to claim 14, wherein said plural kinds of processing include at least one selected from: processing of adjusting microphone sensitivity; processing of adjusting an input level at an appropriate level; processing of compensating for sound in low frequencies; processing of cutting sound in low frequencies; processing of encoding a sound signal; processing of setting a volume level to a value not greater than a prescribed value; processing of starting recording at a predetermined time; and VAS processing of cutting a silent portion.
